(19) United States
(12) Patent Application Publication
(10) Pub. No.: US 2024/0356817 A1
(43) Pub. Date: Oct. 24, 2024

(54) METHODS FOR FEDERATED LEARNING OVER WIRELESS (FLOW) IN WIRELESS LOCAL AREA NETWORKS (WLAN)

(71) Applicant: InterDigital Patent Holdings, Inc., Wilmington, DE (US)

(72) Inventors: Xiaofei Wang, North Caldwell, NJ (US); Zinan Lin, Basking Ridge, NJ (US); Hanqing Lou, Syosset, NY (US); Mahmoud Saad, Montreal (CA); Rui Yang, Greenlawn, NY (US)

(73) Assignee: InterDigital Patent Holdings, Inc., Wilmington, DE (US)

(21) Appl. No.: 18/687,965

(22) PCT Filed: Oct. 4, 2022
(86) PCT No.: PCT/US2022/045676

§ 371 Date: Feb. 29, 2024

Related U.S. Application Data
(60) Provisional application No. 63/252,484, filed on Oct. 5, 2021.

(51) Int. Cl. H04L 41/16; G06N 3/084; G06N 3/098; H04W 28/18

(52) U.S. Cl. CPC H04L 41/16; H04W 28/18; G06N 3/084; G06N 3/098

(57) ABSTRACT

A federated learning (FL) and/or a distributed machine learning (ML) model sharing process may be implemented in a wireless network. An access point (AP), station (STA), or the like may provide a FL announcement message indicating that a FL or ML process is in being utilized. A STA receiving the announcement message may provide a FL/ML support frame indicating its participation in FL model sharing. The STA may comprise a local FL model executable on the STA. The STA may update its local FL model based on information in the FL announcement message. The STA may update its local FL model based on information received from other STAs in the network. The FL announcement message may comprise a schedule, and the STA may be configured to train its local FL model in accordance with the schedule. The sharing model process may be implemented in a wireless local area network.

### CROSS-REFERENCE TO RELATED APPLICATIONS

This application claims the benefit of U.S. Provisional Patent Application No. 63/252,484 filed Oct. 5, 2021, the disclosure of which is incorporated herein by reference in its entirety.

### FIELD OF INVENTION

The invention pertains to federated machine learning in wireless local area networks (WLAN).

### BACKGROUND

A WLAN in Infrastructure Basic Service Set (BSS) mode may have an Access Point (AP) for the BSS and one or more stations (STAs) associated with the AP. The AP may typically have access or interface to a Distribution System (DS) or another type of wired/wireless network that carries traffic in and out of the BSS. Traffic to STAs that originates from outside the BSS may arrive through the AP and may be delivered to the STAs. Traffic originating from STAs to destinations outside the BSS may be sent to the AP to be delivered to the respective destinations. Traffic between STAs within the BSS may also be sent through the AP where the source STA sends traffic to the AP and the AP delivers the traffic to the destination STA. Such traffic between STAs within a BSS may be considered peer-to-peer traffic. Such peer-to-peer traffic also may be sent directly between the source and destination STAs with a direct link setup (DLS) using, for example, an 802.11e DLS or an 802.11z tunneled DLS (TDLS). A WLAN using an Independent BSS (IBSS) mode has no AP, and/or STAs, communicating directly with each other. This mode of communication is referred to as an “ad-hoc” mode of communication.

Federated learning is a distributed machine learning mechanism involving multiple devices. Implementation of federated learning in wireless networks (e.g., WLAN) may utilize highly computational processing and high throughput communications.

### SUMMARY

Described herein are methods and apparatuses for implementing federated learning efficiently without excessive overhead. In federated learning, models and/or model variants may be shared among distributed users and a server, or the like. Methods and apparatuses described herein provide efficient mechanisms for users to share their current machine learning models while maintaining a reduced overhead. Based on an enhanced broadcast service (EBCS) framework, for example, the mechanisms that contain support or enable distributed machine learning (ML) or federated learning (FL) are described. In some federated learning cases, to reduce overhead and the communication burden, a number of variables, e.g., gradients, or gradients of one or more weights that may be part of the model, may be shared among different users utilizing the same learning models to facilitate a fast convergence.

Described herein is an efficient mechanism for users to share their learning model parameters, e.g., gradients of weights, correctly while maintaining a reduced overhead. In example embodiments, to save power, selected clients may not need to be active all the time except when needed. It may be advantageous for the AP to know STA operational parameters for FL, e.g., when the STA is ready to receive the updated training model, the processing capability, an amount of power available to process the data, an amount of data collected for training, etc., or the like, or any appropriate combination thereof. Therefore, FL operational parameter setup and synchronization between the AP and the selected STAs may be implemented. An effective protocol may provide FL operational parameters between the AP and the STAs, as described herein.

In an example embodiment, an access point (AP) may be connected to a ML or FL server. The AP may announce that FL model sharing is in progress. The announcement may be in the form of an announcement frame and may be broadcast, multicast, or any appropriate combination thereof. A station (STA) receiving the announcement may transmit a FL support message indicating that it will participate in FL sharing. A STA receiving the announcement may update a local FL model, executable on the STA, based on information in the announcement. The announcement may comprise a schedule, and the STA receiving the announcement may follow the schedule to communicate with other STAs and/or APs. STAs may provide respective local FL model parameters, and STAs receiving the parameters may update their respective local FL models with the received parameters. Local FL models may be executed, and the results may be provided to the centralized model via the network.

In an example method, a FL model announcement frame may be received by a STA. The FL model announcement frame may be provided by an AP. The FL model announcement frame may comprise an indication of a FL model sharing process. In response to receiving the FL announcement frame, the STA may transmit a FL support frame comprising an indication to participate in the FL model sharing process. The FL support frame may comprise a set of parameters associated with a local FL model. The FL support frame may be broadcast, multicast, unicast directly to the AP, or any appropriate combination thereof. The station may receive a FL support frame transmitted by another station. The station may update its local FL model based on information contained in the received announcement frame, information contained in the received FL support frame, or any appropriate combination thereof. The announcement frame may contain announcement parameters comprising at least one of a FL model identifier (ID), a number of FL model layers, or a number of weights per layer. The STA may be configured to update its local FL model in accordance with the announcement parameters. The announcement frame may contain at least one of an uplink (UL) schedule or a downlink (DL) schedule, and the STA may be configured to transmit and receive in accordance with at least one of the UL schedule or the DL schedule.

According to the method, the STA may receive a trigger frame, and responsive to receiving the trigger frame, sharing its local FL model parameters. Sharing may be accomplished via a broadcast message, a multicast message, a message sent directly to a network entity, or any appropriate combination thereof. The trigger frame may comprise a null data packet feedback report poll (NFRP) frame. The trigger frame may comprise an UL enhanced broadcast service (EBCS) message. Sharing may be accomplished in accordance with at least one of the UL schedule or the DL schedule.

According to the method, the STA may receive a gradient update for its local FL model, and be configured to update its local FL model in accordance with the received gradient update. The STA may train its local FL model and transmit the results of the training. The results may be transmitted via a broadcast message, a multicast message, a unicast message sent directly to a network entity, or any appropriate combination thereof. The STA may receive a message comprising a target wake time (TWT) schedule and may be configured to receive training parameters for its local FL model during the TWT.

An example STA may be configured to perform the above-described method. For example, the STA may comprise a transceiver and a processor. The processor may be configured to receive, via the transceiver, a FL model announcement frame. The FL model announcement frame may be provided by an AP in a network. The FL model announcement frame may comprise an indication of a FL model sharing process. In response to receiving the FL announcement frame, the STA may transmit, via the transceiver, a FL support frame comprising an indication to participate in the FL model sharing process. The FL support frame may comprise a set of parameters associated with a local FL model. The FL support frame may be broadcast, multicast, unicast directly to the AP, or any appropriate combination thereof. The processor may be configured to receive, via the transceiver, a FL support frame transmitted by another station in the network. The STA my update its local FL model based on information contained in the received announcement frame, information contained in the received FL support frame, or any appropriate combination thereof. The announcement frame may contain parameters comprising at least one of a FL model identifier (ID), a number of layers, or a number of weights per layer. The STA may be configured to update its local FL model in accordance with the announced parameters. The announcement frame may contain at least one of an uplink (UL) schedule or a downlink (DL) schedule, and the STA may be configured to transmit and receive in accordance with at least one of the UL schedule or the DL schedule.

The processor of the STA may be configured to receive, via the transceiver, a trigger frame, and responsive to receiving the trigger frame, share its local FL model parameters. Sharing may be accomplished via a broadcast message, a multicast message, a message sent directly to a network entity, or any appropriate combination thereof. The trigger frame may comprise a null data packet feedback report poll (NFRP) frame. The trigger frame may comprise an UL enhanced broadcast service (EBCS) message. Sharing may be accomplished in accordance with at least one of the UL schedule or the DL schedule.

The processor of the STA may be configured to receive, via the transceiver, a gradient update for its local FL model, and be configured to update its local FL model in accordance with the received gradient update. The processor may train its local FL model and transmit the results of the training. The results may be transmitted via a broadcast message, a multicast message, a message sent directly to a network entity, or any appropriate combination thereof. The processor may receive, via the transceiver, a message comprising a target wake time (TWT) schedule and may be configured to receive training parameters for its local FL model during the TWT.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2A illustrates an example target wake time (TWT) element format according to embodiments;

FIG. 2B illustrates an example control field format according to embodiments;

FIG. 2C illustrates an example TWT Parameter Set field format according to embodiments;

FIG. 2D illustrates an example Broadcast TWT Parameter Set field format according to embodiments;

FIG. 3 is an example graph illustrating how Gradient Descent works for one parameter, w, according to embodiments;

FIG. 4A illustrates an example design of ML/FL Model sharing announcement frame according to embodiments;

FIG. 4B illustrates an example design of ML/FL Support Indication frame according to embodiments;

FIG. 4C depicts an example flow diagram of a process for implementing federated/machine learning in a wireless network.

FIG. 5 illustrates an exemplary procedure using null data packet feedback report poll (NFRP) Trigger and null data packet (NDP) Feedback for machine learning gradient report according to embodiments;

FIG. 6A illustrates an example NFRP User Info field AI variant design according to embodiments;

FIG. 6B illustrates an example NFRP User Info field variant for Federated Learning according to an embodiment;

FIG. 6C illustrates an Exemplary Trigger Type subfield encoding for FL Operational Parameter Report according to embodiments;

FIG. 7 illustrates an example procedure to update an FL model using several NDPs in the same triggering session according to embodiments;

FIG. 8A illustrates an Exemplary Trigger Dependent Common Info subfield of FL Operational Parameter Report Trigger Frame according to embodiments;

FIG. 8B illustrates an exemplary EBCS parameter element format for FL according to embodiments;

FIG. 8C illustrates Exemplary Format of Machine Learning Parameters filed for a non-AP STA according to embodiments;

FIG. 9 illustrates an Example of Group TWT Operation for Training Model Update according to embodiments;

FIG. 10 illustrates Example of broadcast TWT operation for FL according to embodiments;

FIG. 11 illustrates an Alternative example of broadcast TWT operation for FL/ML according to embodiments;

FIG. 12A illustrates an Exemplary control field format for a variant of TWT element according to embodiments;

FIG. 12B illustrates an Exemplary Enhanced Group TWT Parameter Set field format for FL according to embodiments;

FIG. 12C illustrates Exemplary Enhanced Broadcast TWT Parameter Set field for FL according to embodiments;

FIG. 13A illustrates an example variant of Broadcast TWT Recommendation field for a broadcast TWT element according to embodiments;

FIG. 13B illustrates an example variant of Broadcast TWT Info subfield format according to embodiments;

FIG. 14 illustrates Exemplary FL Device Control field format according to embodiments;

FIG. 15A illustrates Exemplary Encoding of Available Electronic Power Value according to embodiments;

FIG. 15B illustrates Exemplary Encoding of Available Dataset Value according to embodiments; and

FIG. 15C illustrates Exemplary Encoding of Processing Capability Value according to embodiments.

### DETAILED DESCRIPTION

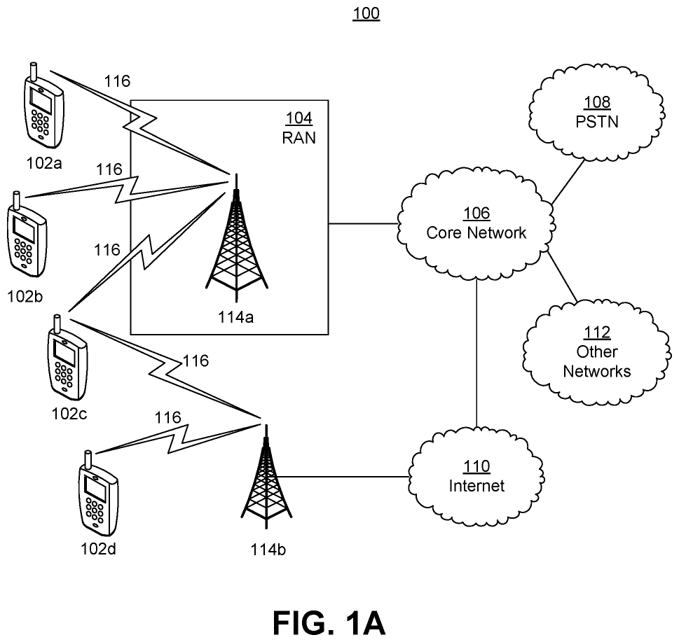

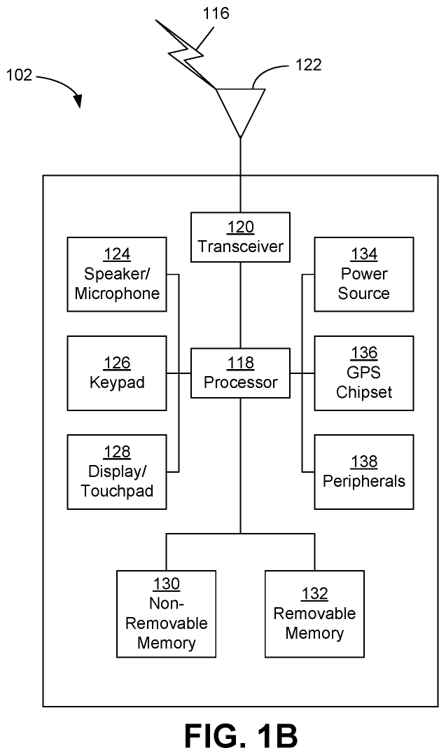

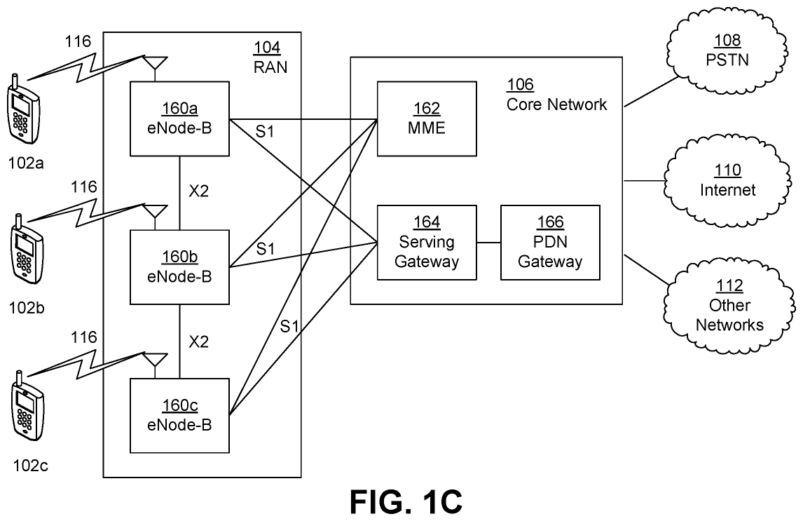

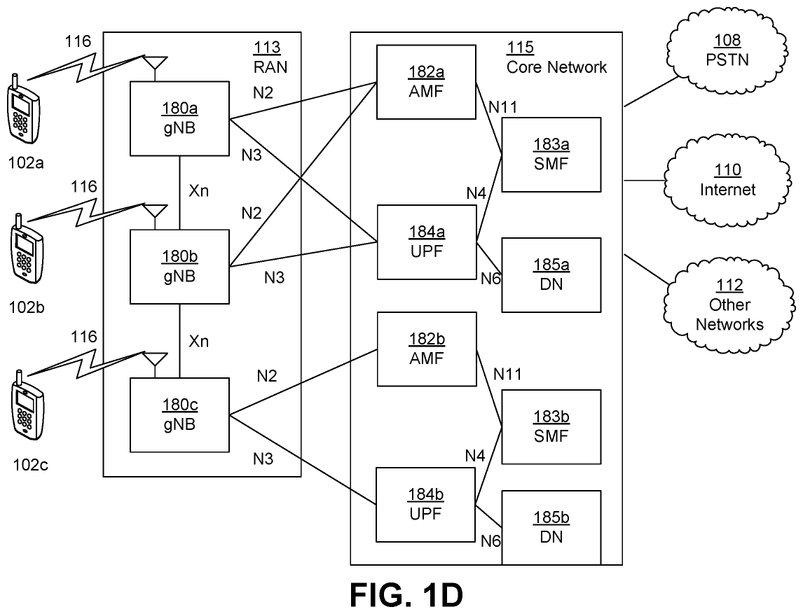

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general-purpose processor, a special-purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data. It should be understood that the embodiments of FIGS. 1A-1D can be configured to perform the methods described in more detail below.

A WLAN in Infrastructure Basic Service Set (BSS) mode may have an Access Point (AP) for the BSS and one or more stations (STAs) associated with the AP. The AP may typically have access or interface to a Distribution System (DS) or another type of wired/wireless network that carries traffic in and out of the BSS. Traffic to STAs that originates from outside the BSS may arrive through the AP and may be delivered to the STAs. Traffic originating from STAs to destinations outside the BSS may be sent to the AP to be delivered to the respective destinations. Traffic between STAs within the BSS may also be sent through the AP where the source STA sends traffic to the AP and the AP delivers the traffic to the destination STA. Such traffic between STAs within a BSS may be considered peer-to-peer traffic. Such peer-to-peer traffic also may be sent directly between the source and destination STAs with a direct link setup (DLS) using, for example, an 802.11e DLS or an 802.11z tunneled DLS (TDLS). A WLAN using an Independent BSS (IBSS) mode has no AP, and/or STAs, communicating directly with each other. This mode of communication is referred to as an “ad-hoc” mode of communication.

Using the 802.11ac infrastructure mode of operation, the AP may transmit a beacon on a fixed channel, usually the primary channel. This channel may be 20 MHz wide, and is the operating channel of the BSS. This channel also may be used by the STAs to establish a connection with the AP. The fundamental channel access mechanism in an 802.11 system is Carrier Sense Multiple Access with Collision Avoidance (CSMA/CA). In this mode of operation, every STA, including the AP, may sense the primary channel. If the channel is detected to be busy, the STA may back off. Hence only one STA may transmit at any given time in a given BSS.

High Throughput (HT) STAs configured to meet the standard specifications of 802.11n are capable of using a 40 MHz wide channel for communication. This is achieved by combining the primary 20 MHz channel, with an adjacent 20 MHz channel to form a 40 MHz wide contiguous channel.

Very High Throughput (VHT) STAs configured to meet the standard specifications of 802.11ac may operate using 20 MHz, 40 MHz, 80 MHz, and 160 MHz wide channels. The 40 MHz, and 80 MHz, channels may be formed by combining contiguous 20 MHz channels similar to 802.11n described above. A 160 MHz channel may be formed either by combining 8 contiguous 20 MHz channels, or by combining two non-contiguous 80 MHz channels, this also may be referred to as an 80+80 configuration. For the 80+80 configuration, after channel encoding, the data may be passed through a segment parser that divides it into two streams. Inverse Fast Fourier (IFFT) and time domain processing may be performed on each stream separately. The streams may then mapped on to the two channels, and the data may be transmitted. At the receiver, this mechanism may be reversed, and the combined data may be sent to the MAC.

STAs configured to meet standard specifications of 802.11af and 802.11ah may operate in Sub 1 GHz modes. For these configurations the channel operating bandwidths, and carriers, may be reduced relative to those used in 802.11n, and 802.11ac standard configurations. STAs configured to meet standard specification 802.11af may operate in 5 MHz, 10 MHz, and 20 MHz bandwidths in the TV White Space (TVWS) spectrum. STAs configured to meet IEEE standard specification 802.11ah may operate in 1 MHz, 2 MHz, 4 MHz, 8 MHz, and 16 MHz bandwidths using non-TVWS spectrum. Embodiments of the invention may be useful in applications in which WLANs include Meter Type Control (MTC) devices in a macro coverage area. MTC devices may have limited capabilities including only support for limited bandwidths, but also include a requirement for a very long battery life.

WLAN systems which support multiple channels, and channel widths, such as 802.11n, 802.11ac, 802.11af, and 802.11ah, may include a channel which is designated as the primary channel. The primary channel may, but not necessarily, have a bandwidth equal to the largest common operating bandwidth supported by all STAs in the BSS. The bandwidth of the primary channel therefore may be limited by the STA, of all STAs in operating in a BSS, which supports the smallest bandwidth operating mode. In the example of 802.11ah, the primary channel may be 1 MHz wide if there are STAs (e.g., MTC type devices) that only support a 1 MHz mode even if the AP, and other STAs in the BSS, may support a 2 MHz, 4 MHz, 8 MHz, 16 MHz, or other channel bandwidth operating modes. Carrier sensing, and Network Allocation Vector (NAV) settings, may depend on the status of the primary channel; e.g., if the primary channel is busy, for example, due to a STA supporting only a 1 MHz operating mode is transmitting to the AP, then the entire available frequency bands are considered busy even though majority of it stays idle and available.

In the United States, the available frequency bands employed by 802.11ah may be from 902 MHz to 928 MHz. In Korea they may be from 917.5 MHz to 923.5 MHz; and in Japan, they may be from 916.5 MHz to 927.5 MHz. The total bandwidth available for operation in compliance with 802.11ah may be 6 MHz to 26 MHz depending on the country code.

An enhanced broadcast service (EBCS) may be downlink from an AP to non-AP STAs or may be uplink from a sensor or other non-AP STAs. An EBCS may be provided to both STAs that are associated or unassociated with a particular AP. An AP may be expected to support up to 3000 non-AP STAs with EBCS. In addition, there may be a class of low-cost non-AP STAs that consumes the EBCS and may not be able to transmit directly to the AP. Some practical applications for EBCS embodiments disclosed herein may include Stadium Video Broadcasting, Automotive broadcasting, Uplink Sensor Data Broadcasting, Museum Information and Multilingual Broadcasting, and Event Producer Information and Content Broadcasting, or the like

A non-AP STA may choose compatible networks for performing authentication and association. Once compatible networks are discovered, the STA may attempt authentication. For example, a STA may send an authentication frame to an AP. The AP may receive the authentication frame and respond to the STA. After the STA is authenticated, the STA may perform an association procedure for enabling data transfers through the AP. The STA may send an association request to the AP. If the AP has the capabilities to support the STA, the AP may create an Association ID for the STA and respond with an association response with a success message granting network access to the STA. The STA is then successfully associated to the AP and data transfer may begin.

Embodiments provide Target Wake Time (TWT) Operation in 802.11ax and 802.11be. Target wake time (TWT) may allow an AP to manage activity in the BSS in order to mitigate contention between STAs and to reduce the required amount of time that a STA utilizing a power management mode may need to be awake. This may be achieved by allocating STAs to operate at nonoverlapping times and/or frequencies, and concentrate the frame exchanges in predefined service periods.

A high efficiency (HE)/extremely high throughput (EHT) STA may negotiate individual TWT agreements. A non-AP HE/EHT STA may establish membership in broadcast TWT schedules. A HE/EHT AP may deliver broadcast TWT parameter sets to non-AP HE/EHT STAs.

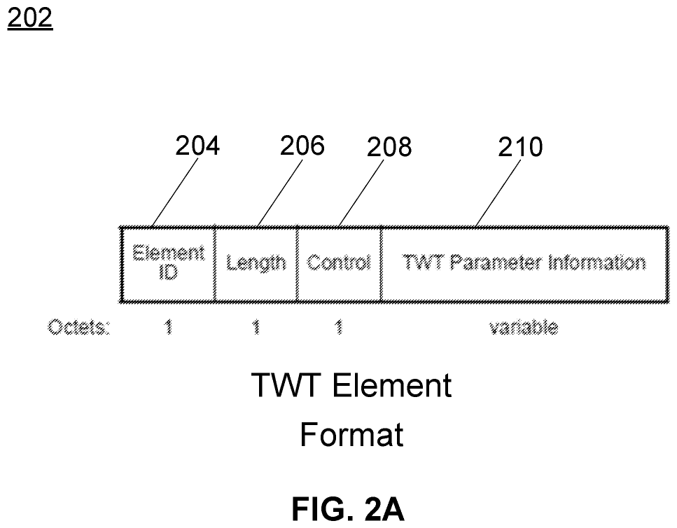

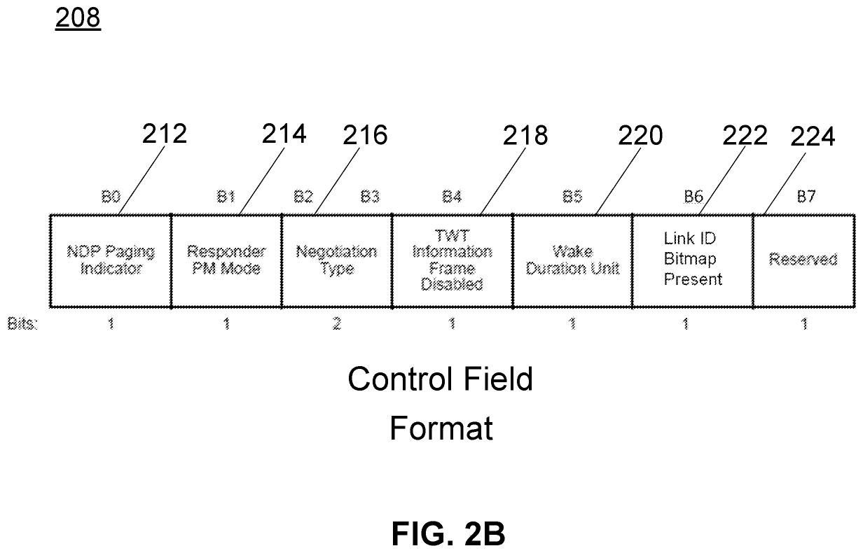

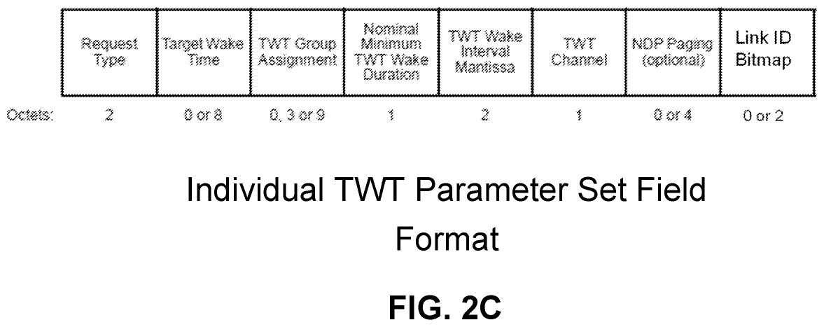

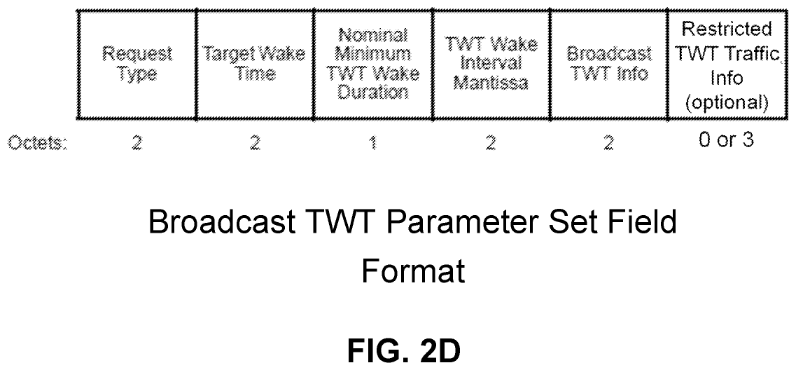

An example TWT element 202 is shown in FIG. 2A. TWT element 202 may comprise Element ID field 204, Length field 206, Control field 208, and TWT Parameter Information field 210. An example format of Control field 208 is shown in FIG. 2B. Control field 208 may comprise NDP Paging Indicator field 212, Responder PM Mode field 214, Negotiation Type field 216, TWT Information Frame Disabled field 218, Wake Duration Unit field 220, Link ID Bitmap Present field 222, and a reserved field 224. The Individual TWT Parameter Set field format and the broadcast TWT Parameter Set field format are shown in FIG. 2C and FIG. 2D respectively.

For purposes of this specification the term ‘machine learning’ refers to one or more computers (e.g., machines) configured in accordance with an algorithm by which the one or more computers are said to learn from experience E with respect to some class of tasks T, and performance measure P, if their performance at tasks in T, as measured by P, improves with experience E.

There are many different kinds of machine learning, depending on the nature of the task T the system will learn, the nature of the performance measure P used to evaluate the system, and the nature of the training signal or experience E given it. Machine learning implementations are classified into three major categories, depending on the nature of the learning “signal” or “response” available to a learning system which is as follows.

Supervised learning refers to the scenario wherein an algorithm learns from example data and associated target responses that can consist of numeric values or string labels, such as classes or tags, in order to later predict the correct response when posed with new examples comes under the category of supervised learning. This approach is similar to human learning under the supervision of a teacher. The teacher provides good examples for the student to memorize, and the student then derives general rules from these specific examples.

Unsupervised learning refers to the scenario wherein an algorithm learns from plain examples without any associated response, leaving the algorithm to determine the data patterns on its own. This type of algorithm tends to restructure the data into something else, such as new features that may represent a class or a new series of un-correlated values. They are quite useful in providing humans with insights into the meaning of data and new useful inputs to supervised machine learning algorithms.

Reinforcement learning refers to a class of problems in which the system or agent has to learn how to interact with its environment. This can be encoded by means of a policy a=π(x), which specifies which action to take in response to each possible input x (derived from the environment state). The difference from supervised learning is that the system is not told which action is the best one to take (e.g., which output to produce for a given input). Instead, the system just receives an occasional reward (or punishment) signal in response to the actions that it takes. This is like learning with a critic, who gives an occasional thumbs up or thumbs down, as opposed to learning with a teacher, who tells you what to do at each step.

Federated Learning is a machine learning setting where the goal is to train a high-quality centralized model while training data remains distributed over a number of clients. One or more clients may have an unreliable or relatively slow network connection. On each round, each client may independently compute an update to the current model based on the client's local data, and communicates this update to a central server, where the client-side updates are aggregated to compute a new global update. The typical clients in this setting may include mobile phones. As such, it may be advantageous to achieve efficient communications. Federated Learning may enable mobile phones to collaboratively learn a shared prediction model while keeping the training data on the mobile phone, decoupling the ability to do machine learning from the need to store the data in the cloud. The training data may be kept locally on users' mobile devices, and the devices may be used as nodes performing computation on their local data in order to update a global model.

In accordance with a naive implementation of Federated Learning, each client may send a full model (or a full model update) back to the server in each round. For large models, this step may be the bottleneck of Federated Learning due to multiple factors. One factor is the asymmetric property of internet connection speeds: the uplink may be slower than the downlink. One way to reduce uplink communication (from the client to the server) cost in Federated Learning is to implement structured updates, where an update from a restricted pace (e.g., speed) can be learned and it can be parametrized using a smaller number of variables. Another is Sketched updates, where a full model is updated. Then it is compressed before sending to the server.

An example measure of the performance of learning utilizes gradient decent. Gradient descent is a first-order iterative optimization algorithm for finding a local minimum of a differentiable function. The idea is to take repeated steps in the opposite direction of the gradient (or approximate gradient) of the function at the current point. Because this is the direction of steepest descent. This function is often defined as a loss or error function J(w) which is used to measure the performance of the learning.

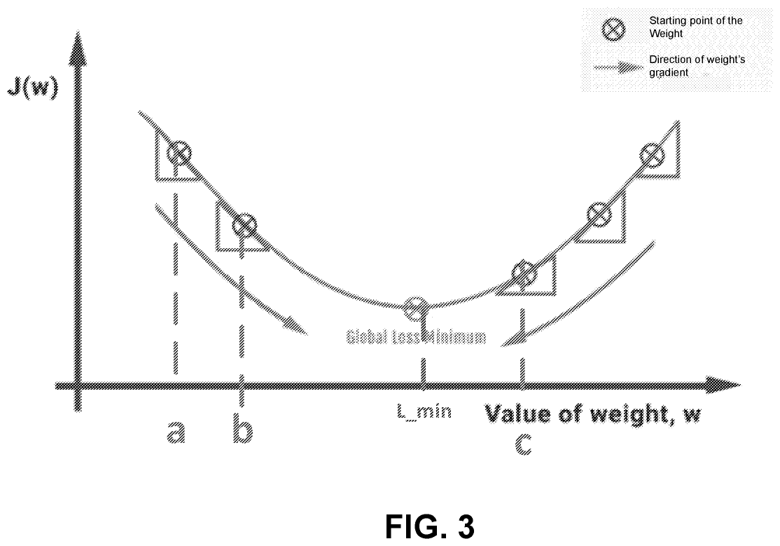

The gradient descent technique is often used to minimize a loss function, J(w) as indicated in FIG. 3. Initially, the model of the output y assigns random weights to the features. So, say it initializes the weight=a. It generates a loss which is far from the minimum point L-min. if the weights are moved towards the positive x-axis, loss function, J(w) can be optimized and the minimum value is achieved. In order to optimize the weight and minimize error, how the error varies with the weights may be checked. To find the derivative of the error with respect to the weight, the derivative may be found. This derivative is called Gradient, i.e.,

$$Gradient = \frac{dJ ( w )}{dw} , if w is a scalar variable$$

$$or$$

$$Gradient = ∇ J ( w ) , if w is a vector of a set of variables$$

If the loss increases with an increase in weight, Gradient will be positive, e.g., at Point c as shown in FIG. 3. If loss decreases with an increase in weight, the gradient will be negative, which corresponds to Point a of FIG. 3. The move towards positive x-axis from Point a to reach Lmin means the gradient is negative. The move towards negative x-axis from Point c to reach Lmin means the gradient is possible. Therefore, the negative of the Gradient shows the directions along which the weights should be moved to optimize the loss function. It is the way the gradient guides the model whether to increase or decrease weights to optimize the loss function.

The process of training a neural network may determine a set of parameters that minimize the difference between expected value and model output, e.g., minimize the loss function. This is done using gradient descent, which comprises two steps: calculating gradients of the loss/error function, then updating existing parameters in response to the gradients, which is how the descent is done. This cycle is repeated until reaching the minima of the loss function. This learning process can be described by the simple equation:

$$W ( t + 1 ) = W ( t ) - \frac{dJ ( W )}{dW ( t )} , where t represents the round t$$

The gradient descent technique works as well in N dimensions. The gradient will indicate which components need to change more and which ones need to change less to reduce the loss function, J(w₁, w₂, w₃, . . . , w_{N}), i.e.:

$$W ( t + 1 ) = W ( t ) - ∇ J ( W ( t ) , where t represents the round t$$

Backpropagation will now be described. In fitting a neural network based on a set of inputs, backpropagation computes the gradient of the loss function with respect to the weights of the network for a single input-output example, and does so efficiently, unlike a naive direct computation of the gradient with respect to each weight individually. This efficiency makes it feasible to use gradient methods for training multilayer networks, updating weights to minimize loss; gradient descent, or variants thereof, such as stochastic gradient descent, are commonly used. The backpropagation algorithm works by computing the gradient of the loss function with respect to each weight by the chain rule, computing the gradient one layer at a time, iterating backward from the last layer to avoid redundant calculations of intermediate terms in the chain rule; this is an example of dynamic programming.

Although the term backpropagation refers to the algorithm for computing the gradient, not how the gradient is used, the term is often used loosely to refer to the entire learning algorithm, including how the gradient is used, such as by stochastic gradient descent.

Federated Learning may be implemented for data usage and model building across organizations while meeting applicable privacy, security and/or regulatory requirements. An architectural framework and application guidelines may be defined for federated machine learning.

The disclosure will address an aspect of Federated Learning Model Sharing. Federated learning has been increasingly deployed in wireless networks. In federated learning, models and/or the model variants can be shared among distributed users and a server. One aspect is how to provide efficient mechanisms for users to share their current machine learning models while considering and/or reducing overhead. Based on the EBCS framework, the mechanisms that contain support or enable distributed ML or Federated Learning may be advantageous.

The disclosure also will address an aspect of Federated Learning Model Gradient Sharing. Federated learning has been increasingly deployed in wireless networks. In some federated learning cases, to reduce the overhead and the communication burden, a number of variables, e.g., gradients, or gradients of one or more weights that may be part of the model, can be shared among different users utilizing the same learning models to facilitate a faster convergence. Thus, an aspect of Federated Learning Model Gradient Sharing is how to provide an efficient mechanism for users to share their learning model parameters, e.g., gradients of weights, correctly while considering and/or reducing overhead.

The disclosure also will address an aspect of operation synchronization in Federated Learning. In Federated learning, to save power, selected clients may not need to be active all the time except when it is needed. The AP may need to know multiple STA operational parameters for FL, e.g., when the STA is ready to receive the updated training model, the processing capability, an amount of power available to process the data, an amount of data collected for training, etc. Therefore, FL operational parameter setup and synchronization between the AP and the selected STAs may be advantageous. Thus, an aspect of operation synchronization in Federated Learning is how to define an effective protocol which provides the FL operational parameters between the AP and the STAs.

The example embodiments discussed below address federated learning or machine learning model sharing. The Enhanced Broadcast Services (EBCS) (e.g., 802.11bc) procedures provide both uplink (UL) and downlink (DL) broadcasting protocols. Such UL and DL broadcasting procedures may be suitable for the AP and the STAs to share their machine learning and federated learning models, weights, gradients, and/or other parameters.

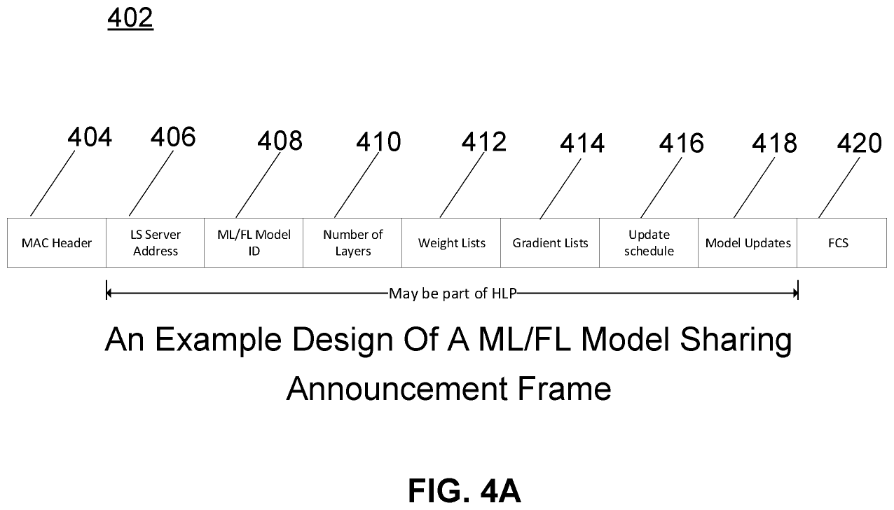

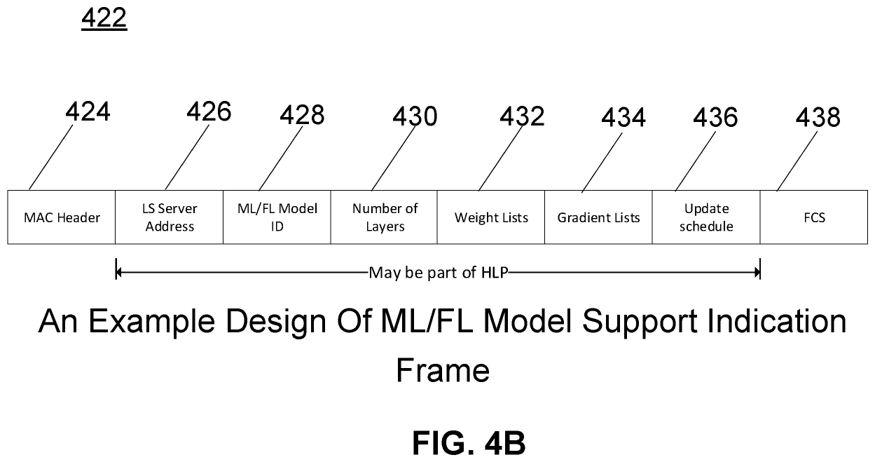

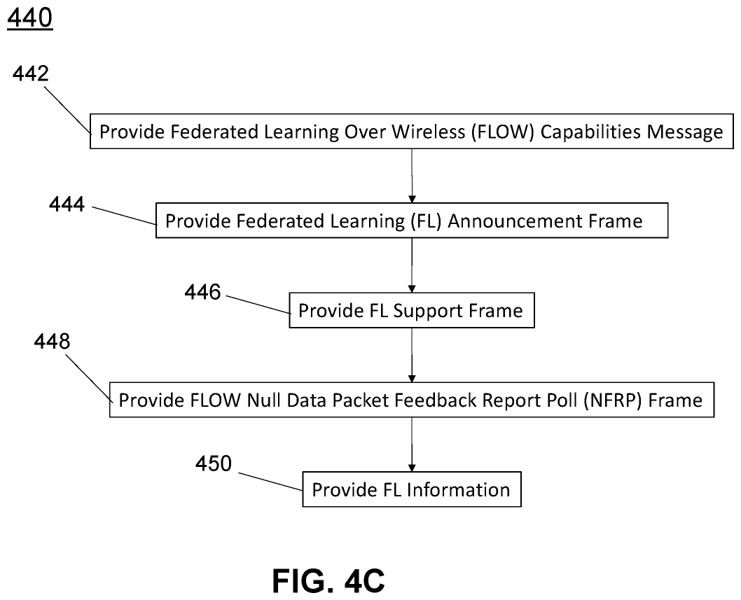

FIG. 4A depicts an example design of a ML/FL Model sharing announcement frame 402ln. ML/FL Model sharing announcement frame 402 may be referred to herein as a FL Announcement frame, an announcement frame, a sharing announcement frame, a ML announcement frame, FL sharing announcement frame, a ML sharing announcement frame, or a ML/FL sharing announcement frame. In one example application, a machine learning and federated learning model-sharing broadcasting procedure may be implemented in a circumstance in which an EBCS STA, such as an EBCS AP or an EBCS non-AP STA, is connected to a machine learning (ML) or federated learning server (LS) and the LS is configured to initiate or execute machine learning or federated learning algorithms in cooperation with one or more of STAs within the area or the network.

The EBCS AP or EBCS STA may broadcast one or more FL announcement frames to announce that machine learning model or federated learning model sharing is currently in progress. Announcement frame 402 may contain one or more fields for communicating parameters related to an ML/FL model. For example, the ML/FL Support Indication frame may include one or more of the following fields: MAC header field 404, learning server (LS) Server Address field 406, ML/FL Model ID field 408, Number of Layers field 410, Weights Lists field 412, Gradient Lists field 414, Update schedule field 416, Model Updates 418, and frame check sequence (FCS) field 420. FCS field 420 may be used to check the integrity of the frame.

The MAC header field 404 may contain a receiver address (RA). The RA may be set to a broadcast address, or an address such as multicast address that is associated with one or more ML/FL model sharing, or to another address that is agreed beforehand. MAC header field 404 may contain a transmitter address (TA). The TA may be set to the MAC address of the transmitter, such as the MAC address of the EBCS AP or STA, or to a multicast address that is associated with one or more ML/FL model sharing.

Learning server (LS) address field 406 is a subfield that may identify the LS server address, which may be an IP address, or MAC address, or multicast address, or any other type of appropriate address.

ML/FL Model identification (ID) field 408 is a subfield that may indicate the ID of one or more ML/FL models.

Number of layers field 410 is a subfield that may indicate the number of layers that should be shared or is going to be shared for the ML/FL model, which may be identified by the ML/FL ID.

Weight Lists field 412 is a subfield that may indicate the number of weights that should be shared or aligned when sharing the ML/FL model. This subfield may contain a list of numbers, with each number being associated with the number of weights that belong to one of the layers. The number of weights per layer may be the same or different. In one example, the number of subfields in Weight lists field 412 may be the same as the value in Number of Layers field 410, with nth subfield contains the value of number of weights for the nth layer, or the (n−1)th layer. If the number of weights is the same for all layers, then the Weight Lists subject may just contain one number that applies to each layer of the ML/FL model.

Gradient Lists field 414 is a subfield that may indicate the number of gradients to be shared or aligned when sharing the ML/FL model. This subfield may contain a list of numbers, with each number being associated with the number of gradients that belong to one of the layers. The number of gradients per layer may be the same or different. In one example, the number of subfields in the Gradient lists is same as the value in Number of Layers field 410, with nth subfield contains the value of number of gradients for nth layer, or (n-1)th layer. If the number of gradients is the same for all layers, then Gradient Lists field 414 may contain one number that applies to all layers of the ML/FL layer.

Update Schedule field 416 is a subfield that may contain UL and/or DL Schedules. A DL Schedule may indicate how often the LS is expected to share its update (regarding layers, weights, and/or gradients, for example) to the ML/FL model, e.g., the schedule of expected transmissions related to the ML/FL by the transmitting STAs. In addition, the DL schedule also may indicate the resource unit (RU) allocation or time allocation for each update, for one or more weights and/or gradients of one or more layers.

An UL Schedule may indicate the schedule for other users/STAs to share their updates of the indicated ML/FL model and may include the IDs of one or more STAs, such as STA ID, MAC addresses, group IDs, etc., which may change from time to time, that are expected to share their updates for one or more weights and/or gradients of one or more layers of the ML/FL model. The IDs may include all or none of the STAs or users. The UL schedule may comprise an indication of an update method, which may indicate whether the sharing of ML/FL model is expected to be triggered by, e.g., a trigger frame, or an enhanced distributed channel access (EDCA) UL transmission. Another method may be for the STAs to share update through UL EBCS broadcast.

The UL schedule may comprise an indication of frequency, which may indicate the frequency at which the one or more STAs are expected to share their updates on one or more gradients of one or more layers of the ML/FL model.

The UL schedule may comprise an indication of Weight/Gradient quantization, which may indicate the quantization for the weights/gradients for which update is being shared. For example, the transmitting STA may indicate that only update direction of the gradients is expected, such as increase or decrease or no change. Or it may indicate that the actual weights or gradient should be transmitted within a [Min, Max] value with a certain quantization level.

Model Updates field 418 may comprise an indication of information pertaining to current LS ML/FL model layers and weights and/or gradients values, as well as applicable updates.

One or more of the fields described herein may be contained in a High Layer Protocol (HLP) container. The ML/FL Announcement frame may be implemented as a frame which may have a HLP container that contains the HLP information needed to transmit the ML/FL related information. The ML/FL Announcement frame may be implemented as public action frame which may have a HLP container that contains the HLP information needed to transmit the ML/FL related information.

The ML/FL Announcement frame/info also may be an element, sub-element, fields, or contained in other frames such as beacon, short beacon, Probe Request, Probe Response frames, Association Request/Response frames, EBCS Info frames, FILS Discovery frames, or the like. In the case of groupcasting or multicasting, a group ID or a set of group IDs or a multi-cast address may be included in the model sharing frame.

FIG. 4B shows an example design of ML/FL Support Indication Frame 422. If an EBCS STA receives an ML/FL Announcement frame, and it can support the ML/FL model updates through EBCS or through other type of transmissions, it may transmit an ML/FL Support Indication frame which may include one or more fields, e.g., for communicating parameters related to an ML/FL model. For example, the ML/FL Support Indication frame may include one or more of the following fields: MAC header field 424, LS Server Address field 426, ML/FL Model ID field 428, Number of Layers field 430, Weights Lists field 432, Gradient Lists field 434, Update schedule field 436, and FCS field 438. MAC header field 424 may comprise a RA address and/or a TA address. The RA address may be set to a broadcast address, or an address such as multicast address that is associated with one or more ML/FL model sharing, or to the MAC address of the EBCS AP from which it has received the ML/FL Announcement frame or to another address that is agreed beforehand. The TA address may be set to the MAC address of the transmitter, such as the MAC address of the EBCS STA, or to a multicast address that is associated with one or more ML/FL model sharing, which may be included in the ML/FL Announcement frame received. LS server address field 426 may identify the LS server address, which may be an IP address, or MAC address, or multicast address.

ML/FL Support Indication frame 422 may further include ML/FL Model ID field 428. This subfield may indicate the ID of one or more ML/FL models. Number of layers field 430 may indicate the number of layers that is going to be shared for the ML/FL model, which may be identified by the ML/FL ID. Weight Lists field 432 may indicate the number of weights that is going to be shared when sharing update of the ML/FL model. This subfield may contain a list of numbers, with each number being associated with the number of weights that belong to one of the layers. The number of weights per layer may be the same or different. In one example, the number of subfields in Weight Lists field 432 may be the same as the value in Number of Layers field 430, where the nth subfield may contain the value of number of weights for the nth layer, or the (n-1)th layer. If the number of weights is the same for all layers, then Weight Lists field 432 may contain one number that applies to all layers of the ML/FL layer.

Gradient Lists field 434 may indicate the number of gradients that is going to be shared when sharing update of the ML/FL model. This subfield may contain a list of numbers, with each number being associated with the number of gradients that belong to one of the layers. The number of gradients per layer may be the same or different. In one example, the number of subfields in Gradient Lists field 434 may be the same as the value in Number of Layers field 430, with the nth subfield containing the value of number of gradients for the nth layer, or (n-1)th layer. If the number of gradients is the same for all layers, then the Gradient Lists subject may contain one number that applies to all layers of the ML/FL layer.

ML/FL Support Indication frame 422 may further include Update Schedule field 436 which may contain UL and/or DL Schedules. A UL Schedule may indicate the expected schedule by the transmitting STA to share its updates of the indicated ML/FL model and may include an update method. An update method may indicate whether the sharing of ML/FL model is expected to be triggered by, e.g., a trigger frame. Another method may be for the STAs to share update through UL EBCS broadcast. The UL schedule may comprise an indication of frequency, which may indicate the frequency at which the transmitting STA is expected to share their updates on one or more weights/gradients of one or more layers of the ML/FL model. The UL schedule may comprise an indication of weight/gradient quantization, which may indicate the quantization for the weight and/or gradients for which update is being shared. For example, the transmitting STA may indicate that only update direction of the weight/gradients is expected, such as increase or decrease or no change. Or it may indicate that the actual weight/gradient should be transmitted within a [Min, Max] value with a certain quantization level.

The ML/FL Support Indication frame 422 may include model updates. For example, the ML/FL Support Indication frame 422 may also contain current ML/FL model layers and weights/gradients values at the transmitting STA, such as current layers, weights or gradients for the FL Model identified by the ML/FL Model ID. One or more of the fields described above may be contained in a High Layer Protocol (HLP) container. The ML/FL Support Indication frame 422 may be implemented as public action frame which may have a HLP container that contains the HLP information needed to transmit the ML/FL related information. If the EBCS Announcement contains Model updates, the receiving EBCS STA may record the indicated ML/FL current layers and/or weight and/or gradient values.

When the EBCS AP or an EBCS STA that transmitted ML/FL Announcement frame receives an ML/FL Support Indication frame that corresponding to the same ML/FL model and with acceptable update settings (e.g., number of layers, number of gradients per layer, gradient quantization levels, etc.), it may record the EBCS STA and monitor the medium for any future updates of ML/FL model. It also may respond with an acknowledgement frame. It also may transmit a trigger frame following a UL Schedule to trigger UL ML/FL model updates, e.g., as contained in a ML/FL Support Indication frame 422, from that EBCS STA.

For an EBCS STA that has received a ML/FL Announcement frame and/or ML/FL Support Indication frame, and it can support ML/FL model for the indicated ML/FL mode with acceptable update settings, it may record the current LS or STA layers and gradients for the indicated ML/FL model. It may subsequently transmit an ML/FL Support Indication frame. The EBCS AP or STA may subsequently follow DL update schedule to transmit ML/FL Announcement frames which may contain update to the ML/FL settings (such as Number of Layers, Number of Gradient per layer) and ML/FL parameters (gradient update directions or gradient values).

The EBCS STA may subsequently follow an UL update schedule to transmit ML/FL Support Indication frames which may include update of ML/FL parameters (gradient update directions or gradient values) according to the updated ML/FL settings as contained in the most recently received ML/FL Announcement frames for the appropriate ML/FL model. The EBCS AP/STA may update their ML/FL model after receiving one or more ML/FL Announcement frames or ML/FL Indication frames.

In one example method, the ML/FL Announcement frame may be transmitted as a broadcast frame. For example, an AP may transmit ML/FL Announcement frame to its associated and unassociated ISTAs, and STAs with capability to do so, may respond with a FL Support Indication Frame. In one method, the ML/FL Announcement frame may be transmitted as an individually addressed frame. For example, an AP may transmit ML/FL Announcement frame to a STA, and the STA may respond with a FL Support Indication Frame.

FIG. 4C depicts an example flow diagram 440 of a process for implementing federated/machine learning in a wireless network. This process may be applicable to, for example, Machine learning and Federated Learning Model Gradient Sharing Broadcasting and Triggering.

At step 442, an AP or STA that is capable of supporting FL over Wireless (FLOW) may indicate its capability in its beacon, short beacon, FILS discovery frames, Probe Request, (Re) Association Request, Association Response frames, or the like, and may include one or more FLOW elements in any frames that it transmits. These frames may be communicated amongst any of APs, STAs, LSs, in the federated ML environment. And thus, transmission of these frames may be from any device to another device or group of devices in the environment. An AP or a non-AP STA may be connected to a machine learning (ML) or federated learning server (LS), and the LS may be planning to conduct machine learning or federated learning with one or more of STAs within the area. At step 444, the AP/STA may broadcast/multicast one or more ML/FL announcement frames to announce that machine learning model or federated learning model sharing is currently in progress. The ML/FL announcement frame may include a FL model identifier (ID), the model layers, the number of weights per layer, downlink (DL) scheduling, uplink (UL) scheduling, or the like. The ML/FL announcement frame may include the ML/FL model and/or parameters. An example ML/FL announcement frame, as described above, is depicted in FIG. 4A. At step 446 a STA may transmit one or more ML/FL Support Indication frames to indicate its participation in FL model sharing. For example, if a STA receives an ML/FL Announcement frame from its associated AP, and it can support the ML/FL model updates, the STA may transmit one or more ML/FL Support Indication frames to indicate its participation in FL model sharing. The ML/FL Support Indication frame may include a FL model ID, the model layers, the number of weights per layer, downlink (DL) scheduling, uplink (UL) scheduling, or the like. The FL Support Indication frame may include the FL model and/or parameters. An example ML/FL Support Indication frame, as described above with reference to FIG. 4B.

An AP may provide one or more FLOW null data packet feedback report poll (NFRP) frames at step 448. The AP may transmit a FLOW NFRP frame to trigger one or more STAs to transmit FL parameters, such as, for example, model/weights/gradients sharing, etc. A FLOW NFRP frame may comprise at least a portion of the FL information to be transmitted by a STA. An AP may utilize NFRP/NFR frames to collect ML/FL model updates. The AP may, e.g., follow the UL schedules indicated by the STAs or by the AP, e.g., in the ML/FL Announcement frames or in ML/FL Support Indication frame, to transmit NFRP frames for ML/FL updates. The NFRP frame may comprise an indication that the current NFRP frame is of the type of ML/FL update poll (referred to as Type info).

The NFRP frame may comprise a ML/FL Model ID, which may indicate the ID of the ML/FL model. The NFRP frame may comprise one or more STA IDs, which may indicate one or more IDs of STAs which may provide updates for the ML/FL Model. The NFRP frame may comprise a Number of LTFs, which may indicate the number of LTFs that the responding STAs should transmit in the UL NDP transmitted in response to the NFRP.

The NFRP frame may comprise a Layer indication, which may indicate one or more layers of the ML/FL model for which gradients update should be provided in the NFR frame transmitted in response. The NFRP frame may comprise a Gradient Indication, which may indicate one or more gradients for which the update should be provided in the NFR frame transmitted in response.

A STA may provide FL information at step 450. For example, if a STA receives a NFRP from its associated STA and it is scheduled to respond, for example, because its ID was indicated in the NFRP, the STA may follow the indicated settings in NFRP frame and transmit the number of LTF fields. In one example, each LTF may be associated with one gradient in a particular layer as indicated in the NFRP.

Each LTF may be modulated to indicate whether the direction of update of the gradient should be increased or decreased. For example, if the first half of the subcarriers within the RU allocated to the STA is modulated while the second half of the subcarriers within the RU allocated to the STA is not modulated, it means that the gradient update direction is increase at the local copy of the ML/FL model; otherwise, the gradient update direction is decrease. In another example, if the first half of the subcarriers within the RU allocated to the STA is not modulated while the second half of the subcarriers within the RU allocated to the STA is modulated, it means that the gradient update direction is increase at the local copy of the ML/FL model; otherwise, the gradient update direction is decrease.

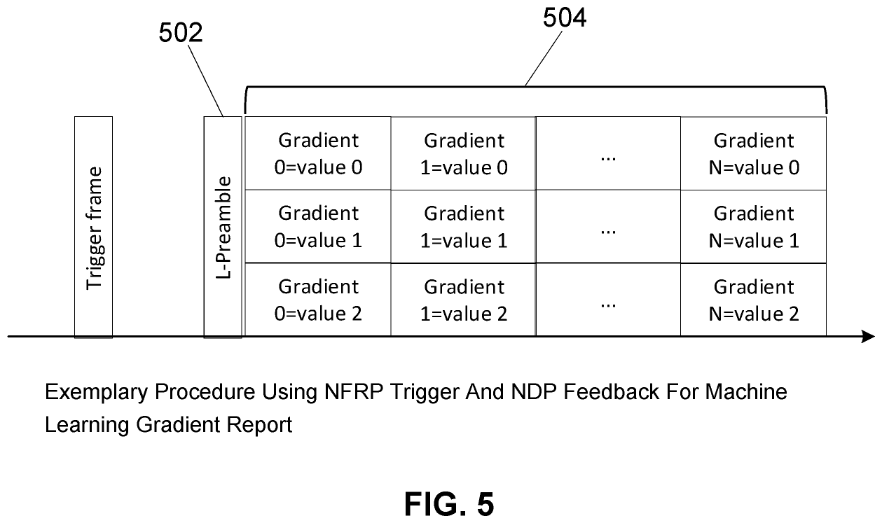

One example embodiment may provide an NFRP (NDP Feedback Report Poll) and NDP Procedure for Machine Learning. In an example embodiment, NFRP trigger frame and NDP frame exchanges in IEEE 802.11 may be modified and used to poll and report AI/machine learning related information such as gradients or gradient descents. An exemplary procedure with gradient update as an example is shown FIG. 5.

An AP may contend and acquire the medium and transmit a modified NFRP Trigger frame to request gradient updates from one or more STAs. The AP may carry gradient update configurations in the Trigger frame. The AP may transmit the gradient update configurations, or configuration options/candidates for the configuration used in modified NFRP Trigger, in a BSS level signaling, such as in an information element/field carried in a management frame, e.g., Beacon frame, Probe Response frame, (Re) Association Response frame etc. The gradient update configuration may include the type of gradients, the set/subset of gradients to be updated, the gradient quantization/resolution etc. The NFRP Trigger frame is discussed below.

STAs which have updated gradients to transmit and/or which have been polled by the NFRP Trigger frame may respond. An STA may transmit a NDP PPDU in response. One exemplary NDP PPDU is shown in FIG. 5. The NDP PPDU may comprise Legacy preamble (L-Preamble) part 502 and Enhanced part 504. Legacy preamble (L-Preamble) part 502 may be transmitted using legacy numerology and transmitted over 20 MHz bandwidth. The transmission of L-preamble part 502 may be repeated on every 20 MHz subchannel on the entire bandwidth or repeated on 20 MHz subchannels which the STA may transmit the gradients. L-preamble part 502 may comprise L-STF field, L-LTF field, L-SIG field, and enhanced SIG field (e.g., U-SIG for EHT STAs). The enhanced SIG field may indicate the version or type of the NDP PPDU. For example, one value in the PHY version field and/or type field may indicate this is an NDP PPDU which carries the AI/machine learning related information. L-preamble part transmitted from multiple STAs may be overlapped in frequency and/or time and thus they may be exactly the same so the AP may detect them correctly.

Enhanced part 504 may comprise the AI/machine learning related information such as gradient. In one method, enhanced part 504 may comprise an enhanced short training field (STF) and an enhanced long training field (LTF). The enhanced STF may be used for auto gain control (AGC) purpose. The enhanced LTF field may be used to carry AI/machine learning related information. The enhanced LTF field may include N_{LTF} symbols in time domain. The enhanced LTF field may carry total K resource units in time/frequency/space domain where the size of the resource unit may be determined and signaled in the NFRP Trigger frame or predefined.

In one example, STAs may report (or may be requested to report) updates for N gradients and each gradient may have M quantized possible values. Then at least M×N resource units may be used to carry them (hence K≥M×N). The resource unit may be a time-frequency-space resource block which may be localized (with contiguous subcarriers) or distributed (with non-contiguous subcarriers). In one method, each resource unit may correspond to a gradient with a value. Transmission on resource unit k may indicate the STA may update gradient x with gradient value or gradient value index y. There may be a predefined/predetermined one to one mapping between k and pair (x,y) For example, resource unit k may correspond to Gradient with

$$x = ⌊ \frac{k}{N} ⌋$$

with value/value index y [symbol] mod(k,M). A STA which may update Gradient

$$⌊ \frac{k}{N} ⌋$$

with value/value index mod(k,M) may transmit a predefined/predetermined sequence on resource unit k. A STA which may update Gradient

$$\text{?}$$

$$\text{?} \text{indicates text missing or illegible when filed}$$

with value/value index other than mod(k,M) may not transmit on resource unit k.

Each resource unit may correspond to a gradient. A STA may transmit different sequences on a resource unit to indicate the STA may update the corresponding gradient with a certain value. The Enhanced part may be transmitted using a different numerology than the L-Preamble part. The Enhanced part may also be pre-coded with CSI to support computation-in-the-air operation in the FL. The sequences transmitted on each RU may be a LTF sequence or part of LTF sequence or LTF sequence with a phase rotation or a modification of LTF sequence.

A UL Trigger with Random Access for Machine Learning may be provided. IEEE 802.11ax allows STAs to participate UL OFDMA via a random access (RA) procedure. In this procedure, any STA receiving the trigger frame without an RU associate to its ID can access one random access Resource Unit. In one embodiment, the trigger frame may use AID=0 or another/other special AID to indicate the availability of resources for random access machine learning (RAML), which allows some STAs or edge devices to transmit ML parameters over the same resources without concern of collision if certain conditions are met. The resources for RAML may be partitioned into several subsets, one for each ML parameters, such as gradient levels and/or model type. The setup of such a resource partition and their association to the meaning in ML may be indicated/signaled in the trigger frame.

For each STA that functions as an edge or local device to conduct updating the local model via local training using local data and believes there is a need to update the global model may provide the update of the ML model or model gradients via the RAML protocol. Based on the interpretation of the resources used for model update or gradient levels provided by in the trigger frame, the edge or local devices may transmit the updated model accordingly. When the transmission from edge devices is the quantized gradients, those edge devices transmitting the same gradient value may conduct the RAML on the same resource assigned for that value without worrying collision. Precoding the transmission based on CSI may be needed (RAML).

A modified NFRP Trigger frame may be used to trigger NDP for ML/FL or other type of transmissions from multiple non-AP STAs concurrently. A NFRP Trigger Frame for a ML/FL design is described below. In an example embodiment, the Feedback Type subfield in the User Info field in the NFRP Trigger frame may have 4 bits which are capable of signaling up to 16 different feedback types. One value may be used and the remaining values may be reserved. A reserved value may be used to indicate that the NFRP Trigger requests AI and/or machine learning and/or Federated learning related feedback. Once the Feedback subfield in User Info field in NFRP Trigger frame is set to this value, the User Info field may be considered as and NFRP User Info field AI variant.

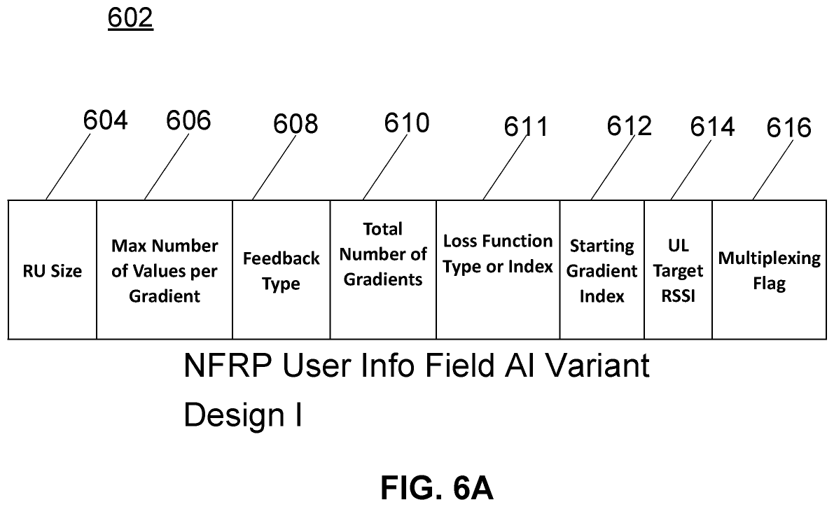

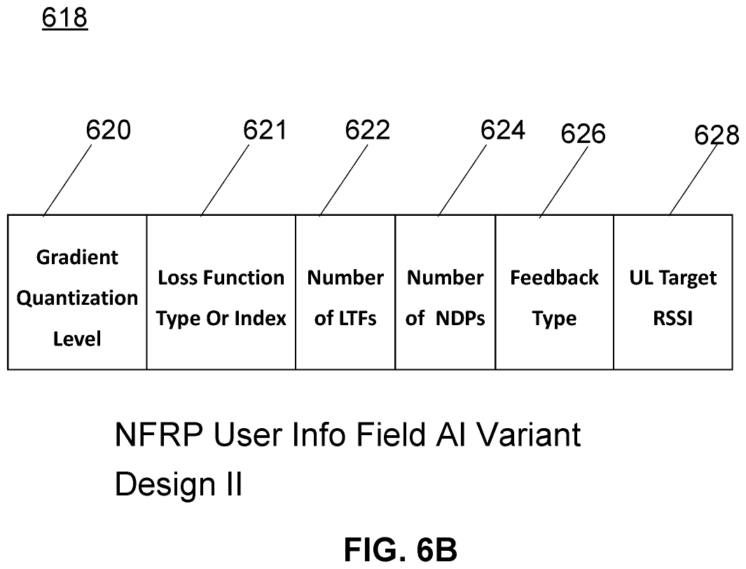

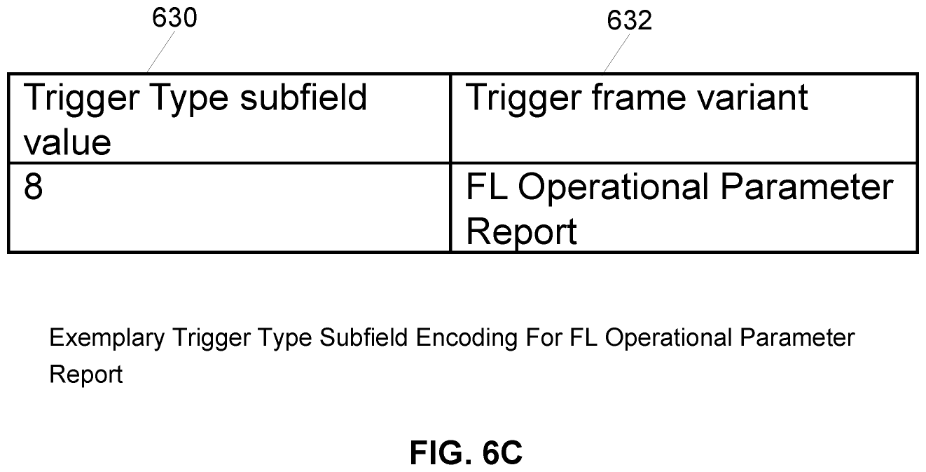

An example NFRP User Info field AI variant 602 is depicted in FIG. 6A. As depicted in FIG. 6A, NFRP User Info field AI variant 602 may comprise RU Size field 604, Max Number of values per Gradient field 606, Feedback Type field 608, Total Number of Gradients field 610, Loss Function Type or Index field 611, Starting Gradient Index field 612, UL Target RSSI field 614, and/or Multiplexing Flag field 616.

RU Size field 604 may indicate the minimum resource unit which may be used to represent a possible value of a gradient. In one example, N possible sizes of RUs may be predefined/predetermined and ordered using index 0 to N-1. In this example, the RU resolution subfield may have log₂ N bits and indicate the index of the selected RU size. For example, [13, 26, 104, 242] tone RUs may be predefined/predetermined with index [0,1,2,3]. When RU Resolution subfield set to 0 may indicate 13 tone RU is used in the following NPD PPDU. Each 13 tone RU may be used to indicate a possible value of a gradient.

Regarding Max Number of Values per Gradient field 606, each gradient may have multiple possible values or multiple quantization levels. This subfield may indicate the maximum allow number of values per gradient, which may be referred to as N_maxValuesPerGradient.

Feedback Type field 608 may indicate a NFRP User Info field AI variant.

Total Number of Gradients field 610 may indicate the total number of Gradients to be included in the following NDP PPDU transmissions, which may be referred to as N_Gradient.

The Loss Function Type or Index field 611: There may be different ways to measure the performance of learning based on different loss function. This loss function may be chosen to be the same or related (i.e., have some dependencies) for different local devices. A list of possible loss functions may be predefined and indexed, which may be signaled to the local devices.

Starting Gradient Index field 612 may be ordered with gradient index. The gradients and corresponding indices may be known at both transmitter and receiver side. This subfield may indicate the starting gradient index. With this subfield present, and together with Total Number of Gradient sub-field 610, a range of Gradients may be identified. With this feature, the transmitter may collect updates for part of Gradients each time.

UL Target RSSI field 614 may be used for UL power control so that the transmissions from multiple STAs may arrive the AP with similar power level.

Multiplexing Flag field 616 may indicate the number of data streams allowed for the upcoming NDP PPDU. We may denote it as N_{SS}.

A non-AP STA which received the NFRP AI Trigger frame may calculate the number of LTF symbols in the NDP PPDU using below equation:

$$\text{?}$$

$$\text{?} \text{indicates text missing or illegible when filed}$$

Where N_{SC} is the total number of subcarriers, N_{RU} is the number of subcarriers in the RU indicated by the RU size subfield.

The design shown in FIG. 6A may be used by an AP to request gradient updates from any STA. In another example, a selected set of STAs may be asked to send the updated gradients. The following subfields (not shown in FIG. 6A) may be added to the User Info field of NFRP Trigger frame AI variant of FIG. 6A. A Starting AID subfield may indicate the starting AID or the minimum AID of the selected subset of STAs. A Number of AIDs subfield may provide STAs with AID range within the range [Starting AID, Starting AID+Number of AIDs−1] may respond the NFRP AI Trigger frame.

A NFRP Trigger Frame for a second ML/FL Design is described below. Described herein are at least two different formats for the User Info filed in an NFRP trigger frame. These may be used alone or in any combination. An example User Info field of NFRP trigger frame 618 is depicted in FIG. 6B. NFRP User Info Field AI Variant Design II 618, as shown in FIG. 6B, may comprise a Gradient Quantization Level field 620, Loss Function Type or Index field 621, a Number of LTFs field 622, a Number of NDPs field 624, a Feedback Type field 626, and a UL Target RSSI field 628.

Gradient Quantization Level field 620 may specify the number of quantization levels of the gradient of a given FL model parameter. Two or more bits may be used to encode the number of quantization levels. For example, Gradient Quantization Level=1 may indicate that the gradient may have 3 values (−1, 0, 1). In another example, Gradient Quantization Level=2 may indicate that the gradient may have 5 values (−2, −1, 0, 1, +2). Accordingly, the number of subcarriers required to transmit the gradient of one parameter may be derived as the same number of quantization levels. For example, Gradient Quantization Level=1 may indicate that 3 subcarriers are required to transmit the gradient value. Moreover, the number of parameters that can be carried in one LTF symbol may be derived by considering the bandwidth used to transmit the NDP.

Regarding loss function type or index field 621, there may be different ways to measure the performance of learning based on different loss function. This loss function may be chosen to be the same or related (i.e., have some dependencies) for different local devices. A list of possible loss functions may be predefined and indexed, which may be signaled to the local devices.

Number of LTFs field 622 may specify how many LTFs are expected from each participating STA in this FL model update round. In some FL models, the number of parameters may be huge and this may utilize a large number of LTFs to transmit the entire FL model parameters which may exceed the capability of the participating STAs.

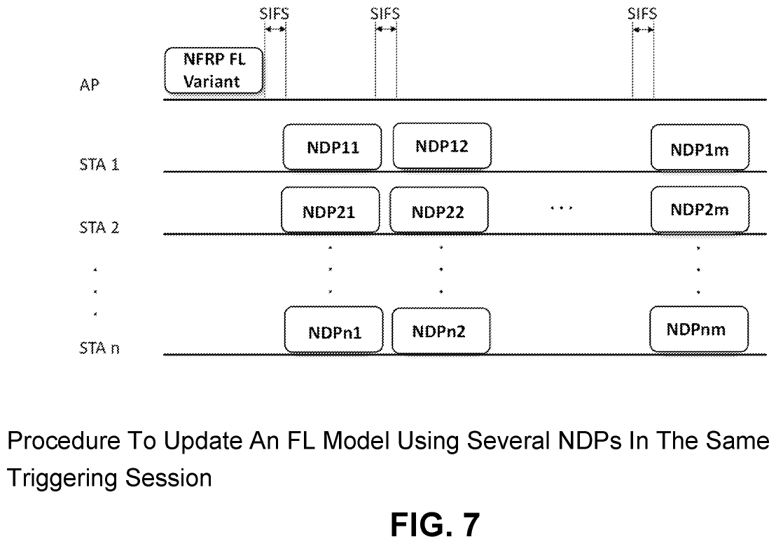

Number of NDPs field 624 may specify how many NDPs are expected from each STAs in this triggering session. Since the number of LTFs in one NDP may be limited, multiple NDPs may be utilized to transmit subsequent parts of the FL model where each NDP may carry a subset of the FL model parameters gradient. Subsequent NDPs may be sent a short interframe spacing (SIFS) (or any other inter-frame space) from each other as a response to the same NFRP trigger frame as depicted in FIG. 7.

Feedback Type field 626 may specify the expected type of NFRP feedback as described above.

UL Target RSSI field 628 may be used for UL power control so that the transmissions from multiple STAs may arrive at the AP with similar power level.

Aspects of operation synchronization in Federated Learning are described below. A trigger frame for FL Operational Parameter Report (FLOPR) may be provided. The individual STA may send its desired wake up time, i.e., target wake time to the AP, and the processing capability, etc. to the AP. These parameter reports may be either initiated or requested or solicited by the AP or sent by the STA unsolicited or without initiating or requesting. After the AP receives the parameter reports from different STAs, the AP may make the following determinations but not limited to: the number of STAs that can be used in the same TWT period; STAs that are scheduled in the same TWT period; the model running time in the STAs; the required updates from the STAs, or the like, or any appropriate combination thereof. The TWT Service Period (SP) after a doze time may be used for FL update, which includes the most recent training model update or training plan from the AP or the model update from the local devices, e.g., non-AP STA.

The AP may use the trigger frame to request one STA or multiple STAs to report the operational parameters. The value of Trigger Type subfield in Common Infor field of EHT variant may be any one from 8 to 15. FIG. 6C indicates an exemplary trigger type subfield encoding for FL Operation Parameter Report. In this example it shows that when Trigger Type subfield 630 value is 8, the corresponding Trigger frame type 632 is FL Operational Parameter Report. The RA field of FL Operational Parameter Report Trigger Frame may be set to the broadcast address or set to the MAC address of the group for which the operational parameters are being requested.

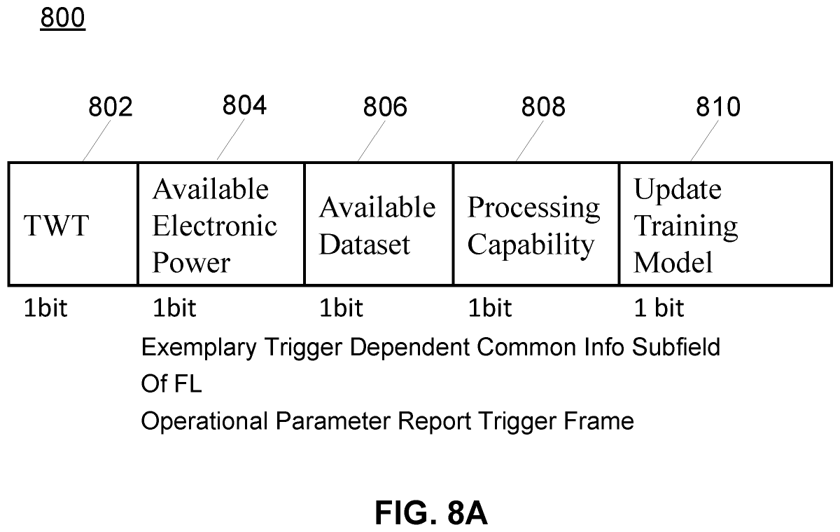

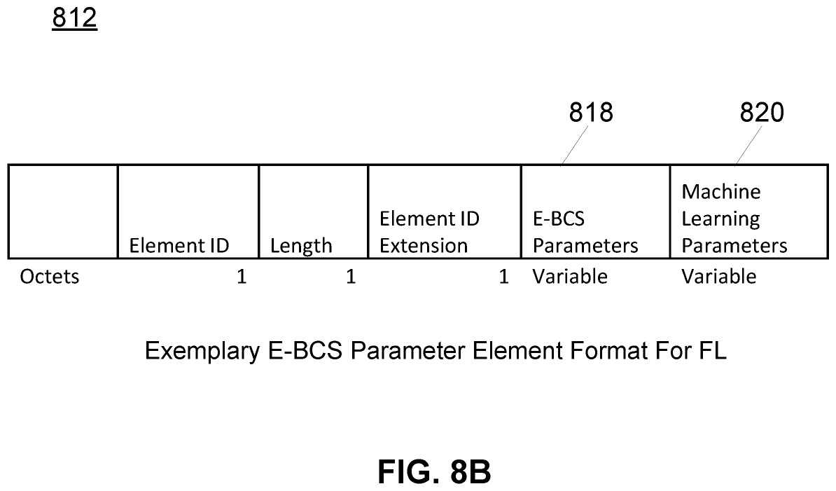

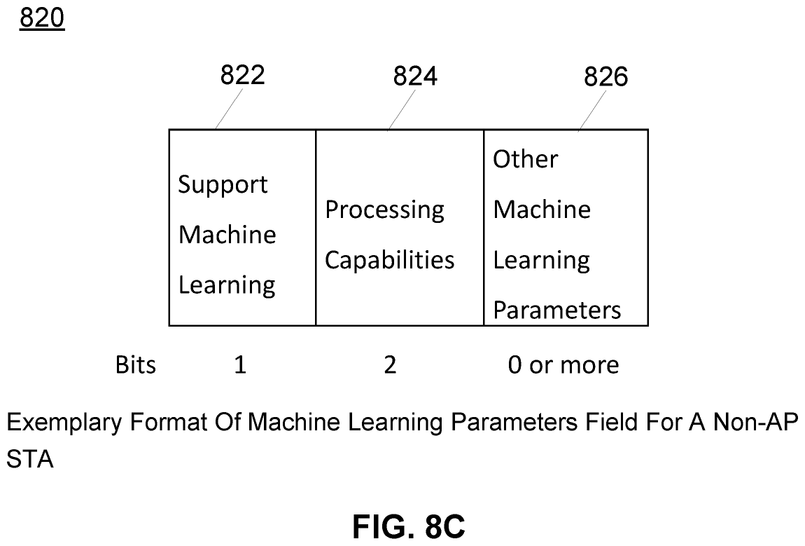

If the requested operational parameters are common for all STAs, it may be included in the Trigger Dependent Common Info subfield 800 of the FL Operational Parameter Report Trigger Frame. FIG. 8A depicts an exemplary Trigger Dependent Common Info subfield of FL Operational parameter Report Trigger Frame. The parameters of the Trigger Dependent Common Info subfield of FL Operational parameter Report Trigger Frame may include some or all information described herein. For example, the parameters may include the TWT 802, which may request the STA(s) to send the TWT related parameters, e.g., TWT element. For example, if the value of the TWT subfield is 1, it may represent that the AP requests the STA to send the TWT related parameters; if the value of the TWT subfield is 0, it may represent that the AP does not request the STA to send the TWT related parameters. The parameters of the Trigger Dependent Common Info subfield 800 may include the available electronic power 804, which may request the STA(s) to indicate it uses a charge or is battery operated. For example, if the value of the Available Electronic Power subfield is 1, it may represent that the AP requests the STA to indicate if it is battery operated or not. If the value of the Available Electronic Power subfield is 0, it may represent that the AP does not request the STA to indicate if it is battery operated or not. If the STA is battery operated, the STA may indicate the remaining battery power level, e.g., high, med, or low. The parameters of the Trigger Dependent Common Info subfield 800 may include the available dataset 806, which may request the STA(s) to indicate if it has any new training data being collected in the device, e.g., during a certain period. The parameters of the Trigger Dependent Common Info subfield 800 may include the processing capability 808, which may request the STA(s) to indicate the processing capability, e.g., how many GPUs are available in the STA. For example, if the value of the Processing Capability subfield is 1, it may indicate that the AP requests the STA to indicate the processing capability (e.g., the number of GPU available in the STA). If the value of the Processing Capability subfield is 0, it may indicate that the AP does not request the STA to indicate the processing capability. The parameters of the Trigger Dependent Common Info subfield 800 may include the updated training model 810, which may request the STA(s) to feedback the updated training model or updated training model parameters. For example, if the value of the updated training model subfield is 1, it may indicate that the AP requests the STA to send the updated training model (or training model parameters). If the value of the Updated Training Model subfield is 0, it may indicate the AP does not request the STA to send any updated training model (or training model parameters).

If the parameter value of the Trigger Dependent Common Info subfield 800 is indicated as 1, for example, then it may mean the corresponding parameter is requested; if the parameter value is indicated as 0, it may mean the corresponding parameter is not requested. For example, if the Trigger Dependent Comm Info subfield is 11010, it may mean that TWT, available electronic power, and processing capability are requested from all STAs; if the Trigger Dependent Comm Infor subfield is 00001, it may mean that the updated training model (or the updated training model parameters) are requested from all STAs.

The requested parameters also may be included in the Trigger Dependent User Info subfield, e.g., HE variant User Infor field, EHT variant Use info field, Special Use Info field, etc. In addition, this type of trigger frame also may be used as an indication that it will transmit the training model in the next coming PPDU, e.g., EHT MU PPDU. For example, if all the parameter values are equal to 0, it may mean it does not require the STAs to report but to deliver the most recent updated training mode. The trigger frame also may be used as an indication of the training plan from the AP.

There may be more types of operational information which are requested from the AP. Therefore, the length or the contents of the Trigger Dependent Common Info subfield or the Trigger Dependent User Info subfield may differ from what is depicted in FIG. 8A.

The processing capability may be included in a non-AP STA Capabilities element. For example, an exemplary EBCS Parameters element format for FL is depicted in FIG. 8B. FL/ML Parameters subfield 820 depicted in FIG. 8B may indicate the Machine Learning (ML) capabilities of a non-AP STA. The processing capability may be reported from the non-AP to the AP in any appropriate manner. For example, the processing capabilities may be included in the response to the Trigger frame sent from the AP. The processing capabilities may be included in the Capabilities element, which may be reported to the AP when the non-AP STA is associated with the AP.

An exemplary format of Machine Learning Parameters field 820 for a non-AP STA is depicted in FIG. 8C. Machine Learning Parameters field 820 may include a Support Machine Learning field 822. The Support Machine Learning field 822 may include one or more bits to indicate whether the STA supports machine learning. For example, the Support Machine Learning field 822 may include 1 bit), wherein 1 represents supporting machine learning and 0 represents not supporting machine learning. The Machine Learning Parameters field 820 may include a Processing Capabilities field 824. The Processing Capabilities field 824 may include one or more bits to indicate the processing capabilities of the STA. For example, the Processing Capabilities field 824 (e.g., 2 bits) may indicate the number of GPUs the STA has or other related processing capabilities. The number of bits for Processing Capabilities may not be limited to 2. There may be other ML related parameters 826 that may be provided in the Machine Learning Parameters field 820.

Machine learning related parameters may be negotiated between AP and non-AP STAs during TWT setup or negotiation phase by using enhanced TWT elements. For example, one or more fields/subfields described herein may be carried in enhanced a TWT element, or elements. In another example, one or more fields/subfields described herein may be carried in ML/FL Model sharing announcement frame 402 and/or ML/FL Support Indication frame 422.

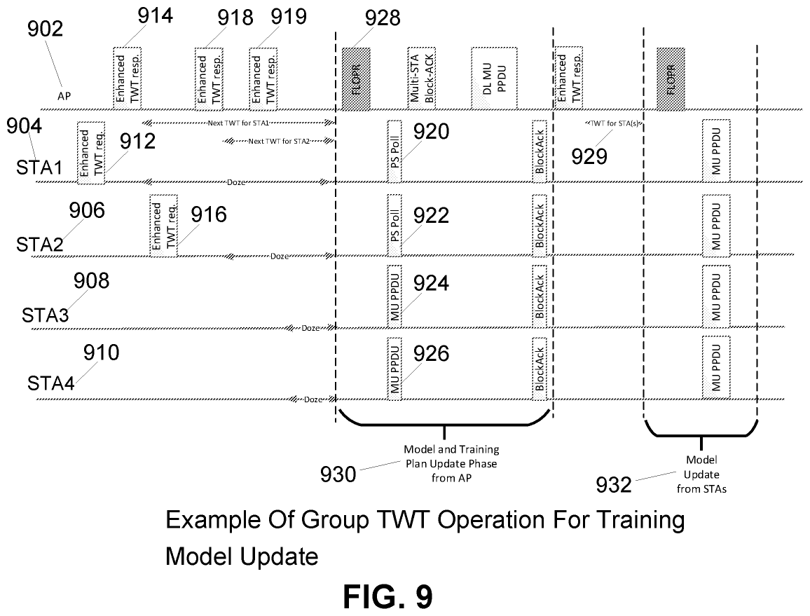

Some embodiments may provide Enhanced TWT Operation, e.g., Group TWT Operation for FL. In one embodiment, one or multiple STAs may request a training model exchange, or training model parameter exchange, via a TWT procedure. The TWT time for the requesting STAs and the number STAs what will be scheduled during the next TWT may be determined by the AP. An example of group TWT operation is depicted in FIG. 9, where AP 902 is the TWT responding STA, and STA1 904, STA2 906, STA3 908, and STA4 910 are the TWT requesting STAs. Although Group TWT operation is described for the FL training model update, it not limited thereto, and is applicable to other use cases.

FIG. 9 illustrates an Example of Group TWT Operation for Training Model Update. In this example, STA1 904 may send an enhanced TWT request 912 to TWT responding STA 902 to set up a trigger-enabled TWT agreement for training model update. TWT responding STA 902 may accept the TWT agreement with STA1 904 and may confirm the acceptance in TWT response 914 sent to STA1 904. Before the next TWT for STA1 904, TWT responding STA 902 may receive another TWT request 916 from STA2 906 to set up a trigger-enabled TWT agreement for training model update. TWT responding STA 902 may accept the TWT agreement with STA2 906 and may confirm the acceptance in TWT response 918 sent to STA2 906. Subsequently, TWT responding STA 902 may send an unsolicited TWT setup as announced TWT 919, which may be received by multiple STAs, e.g., STA3 908 and STA4 910.

During trigger-enabled TWT Service Period (SP) 930, STA 902 may send a federated learning operational parameter report (FLOPR) Trigger frame or basic trigger frame 928 to which TWT requesting STAs may indicate that they are awake during the TWT SP. For example, STA1 904 and STA2 906 may indicate that they are awake by sending respective PS-Poll frames 920, 922 and STA3 908 and STA4 910 may indicate that they are awake by sending respective QoS Null frames 924, 926 (depicted as message unit (MU) physical layer protocol data unit (PPDU) in FIG. 9) in response to FLOPR or the Basic Trigger frame 928. In another example, AP 902 may request FL related information from STA3 908 and STA4 910, e.g., available electronic power, available dataset, processing power or desired TWT, and STA3 908 and STA4 910 may send the requested information to AP 902. STA1 to STA4 904, 906, 908, 910, may receive respective DL Bufferable Units (BUs) in a subsequent exchange with TWT responding STA 902, e.g., the update channel model or training plan, and go to a doze state outside of this TWT SP.

Within first Trigger-enabled TWT service period (SP) 930 for training model update, responding STA 902, e.g., AP, may indicate to STAs 904, 906, 908, 910, that there is another Trigger-enabled TWT SP after this. This indication may be carried in the training model update or training plan sent by the AP. If the indication is sent to STAs, then another TWT SP 932 may be facilitated via the unsolicited TWT setup as announced TWT, which may be sent to STA1 to STA4 904, 906, 908, 910. During this period “doze” time 929, the STAs may do the local training and obtain the training update. When the 2nd TWT SP 932 comes, it may be designed to have these STAs, 904, 906, 908, 910, report their updated training model per AP's request. TWT SP 932 may be called Training Model Update from STAs.

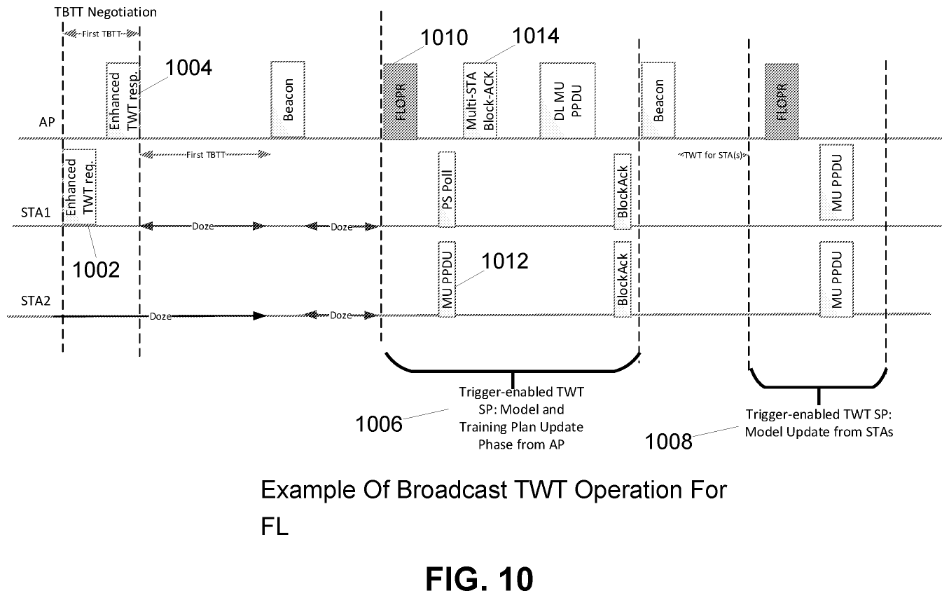

Some embodiments may provide Enhanced Broadcast TWT Operation for FL. If the TWT scheduling AP indicates it supports ML/FL in the Capabilities element and the TWT scheduled STA sets the ML or FL support in the Capabilities element, then the broadcast TWT operation for FL can be enabled. An example of broadcast TWT operation is shown in FIG. 10. In this example, the AP is the TWT scheduling AP which supports ML/FL, STA1 and STA2 are the TWT scheduled STAs which support ML/FL.

FIG. 10 illustrates an example of broadcast TWT operation for FL. In FIG. 10, STA1 may negotiate the “doze” time with the AP. During this negotiation, STA1 may send Enhanced TWT Request 1002 to the Target Beacon Target Time (TBTT) scheduling AP via Enhanced TWT request. This Enhanced TWT request may include the following ML/FL related parameters but not limited to: Available electronic power, e.g., how much battery power remained in the system or it is in charge; Available dataset, e.g., how many data available to train the model; Available processing capability, e.g., how many GPUs are available to process the current dataset; Estimated training time, e.g., how long to get the training results, or the like, or any appropriate combination thereof.

The TBTT scheduling AP that receives a TWT request from the STA may send to STA1 the Enhanced TWT response (e.g., response 1004 depicted in FIG. 10) which may include but not limited to: The TWT time for sending the updated training model or the training plan. The TWT scheduling AP may include an enhanced broadcast TWT element in the Beacon frame that indicates a broadcast TWT SP during which the AP may intend to send Trigger frames, or DL BUs to the TWT scheduled STAs.

During trigger-enabled service period (SP) 1006, the AP may send a Basic trigger frame in which STA1 and STA2 indicate that they are awake during the TWT SP. The AP also may send FLOPR trigger frame 1010 to request STA1 and STA2 to send the FL/ML operational parameters. Since STA1 sent the enhanced TWT request before SP 1006, it may send FL/ML operational parameters to the AP via an Enhanced TWT request. STA1 may indicate that it is awake by sending a PS-Poll. STA may send MU PPDU which carries the FL/ML operation parameters requested by the AP. STA1 and STA2 may receive the latest training model and/or the training plan from the AP via DL MU PPDU 1012 after the AP sends ACKs 1014 to STA1 and STA2. In the next beacon, the AP may indicate the TWT for another trigger-enabled SP 1008, which may be used for collecting the model updates from STA1 and STA2. STA1 and STA2 may go to a “doze” state outside of the TWT SPs 1006, 1008. During the “doze” state between these two SPs, STA1 and STA2 may perform local machine learning training.

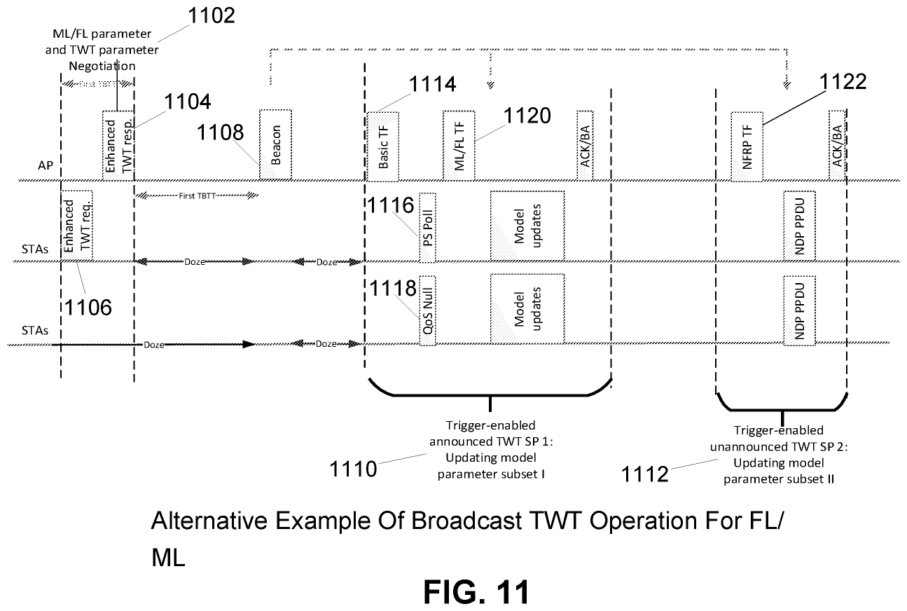

Example embodiments may provide Enhanced Broadcast TWT Operation. Another example of using broadcast TWT to update model parameters is shown in FIG. 11. ML/FL parameter negotiation phase 1102 may be performed using enhanced TWT request/response frame (1104, 1106) exchanges. In an example embodiment, an enhanced TWT element may carry information related to ML/FL parameters.

Beacon frame 1108 may carry TWT element including one or more TWT parameter sets. A TWT parameter set may indicate a TWT SP used to carry ML/FL model updates/Gradient updates parameters. For example, as shown in FIG. 11, two TWT parameter sets (1110, 1112) may be included in the TWT element transmitted in the Beacon frame. Each TWT parameter set may correspond to a TWT which may be used to carry a set or subset of ML/FL model parameters.

A TWT SP may be announced as a such where a non-AP STA may need to transmit PS-Poll or other type of frame to indicate it may be in awake state or unannounced TWT where a non-AP STA may not indicate it may be in awake state. Different frame exchanges may be allowed in different TWT SPs.

An Enhanced TWT Element for FL is described below with reference to FIG. 11. In an example embodiment, a variant of TWT element may utilized for FL communications. As shown in FIG. 11, during TWT SP 1 1110 (announced TWT), the AP may transmit basic Trigger frame 1114 and the STAs may respond with PS-Poll frame or QoS Null frame or other type of frames (1116, 1118) to indicate they are in awake state. The AP may transmit another Trigger frame 1120 to ask for the ML/FL updates. The Trigger frame and response frames may be NFRP and NDP frames disclosed above, or FLOPR related frame exchanges disclosed below.

During TWT SP 2 1112 (unannounced TWT), the AP may transmit a Trigger frame 1122 to ask for the ML/FL updates. The Trigger frame and response frames may be NFRP and NDP frames disclosed in above, or FLOPR related frame exchanges disclosed above.

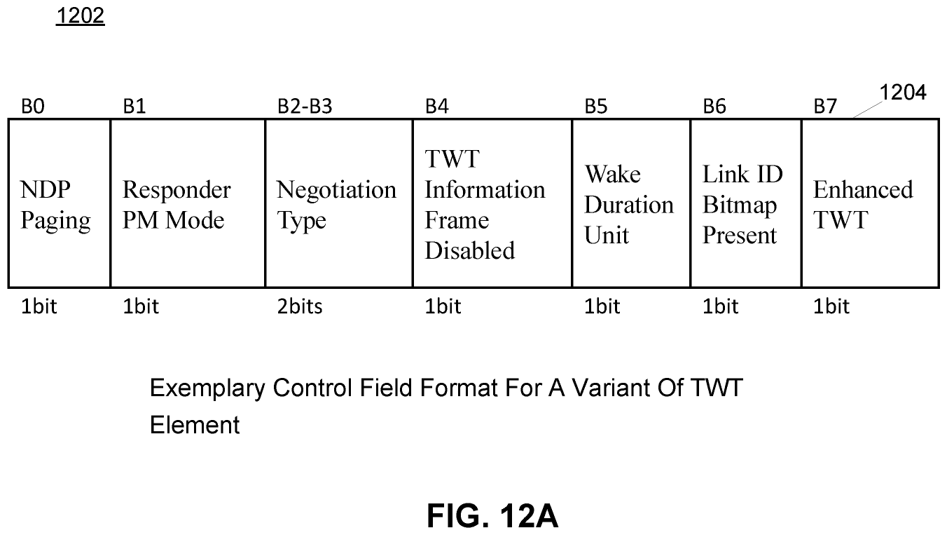

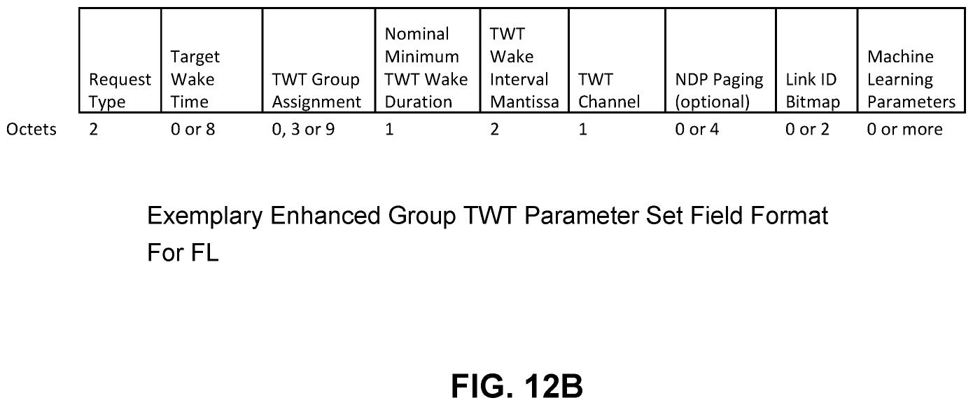

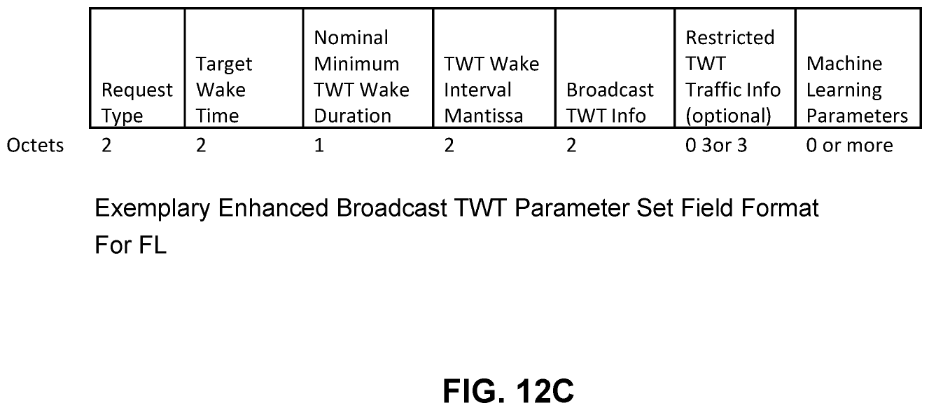

In an example embodiment, a variant of TWT element may be utilized for FL communications. FIG. 12A depicts an exemplary control field format 1202 for a variant of TWT element. B0 through B7 are labels representing bits included in respective subfields. As depicted in control field 1202, an Enhanced TWT subfield 1204 may be included that indicates if it is used for FL TWT operation or not. For example, the Enhanced TWT subfield 1204 may include one or more bits (e.g., 1), labeled as B7, that represent it is used for FL TWT operation. The Enhanced TWT subfield 1204 may include one or more bits (e.g., 0), labeled as B7, that may represent it is not used for FL TWT operation. When the Enhanced TWT subfield 1204 is 1, for example, it may indicate that it is used for FL TWT operation. The TWT Parameter information subfield in TWT element may follow the FL TWT Parameter Set field format.

In an example embodiment, the enhanced Group TWT Parameter Set field format may be as depicted in FIG. 12B. Machine Learning Parameters may be added. If Enhanced TWT subfield in the control field of TWT element is 1, then Machine Learning Parameters field in Enhanced Group TWT Parameter Set may have values in the Machine Learning Parameters subfield, which may include the ML related parameters, e.g., available dataset, available power, available processing capability etc.

FIG. 12C depicts an exemplary Enhanced Group TWT Parameter Set field format for FL. If Enhanced TWT subfield in the control field of TWT element is 1, then Machine Learning Parameters field in Enhanced Broadcast TWT Parameter Set may have values in the Machine Learning Parameters subfield, which may include the ML related parameters, e.g., available dataset, available power, available processing capability, etc.

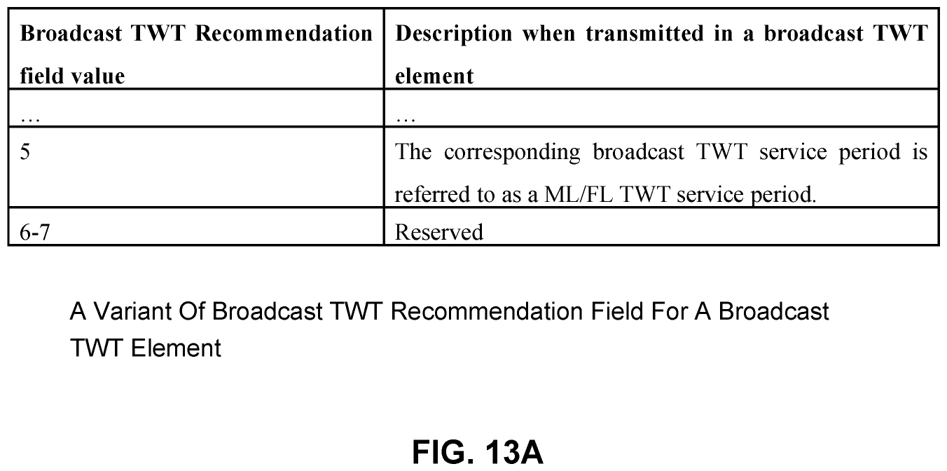

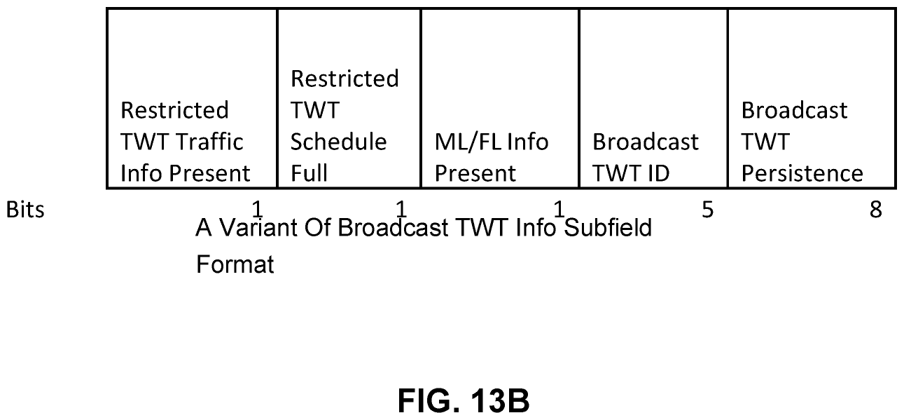

The Broadcast TWT Recommendation field may be included in the Request Type subfield of Enhanced Broadcast TWT Parameter Set Field. A variant of Broadcast TWT Recommendation field for a broadcast TWT element is depicted in FIG. 13A as an example.

An example of a variant of Broadcast TWT Infor subfield format is depicted in FIG. 13B. A ML/FL Traffic Info Present subfield, when included in the Broadcast TWT Info subfield, may be set to 1 to indicate that Machine Learning Parameters field is present; and set to 0 otherwise.

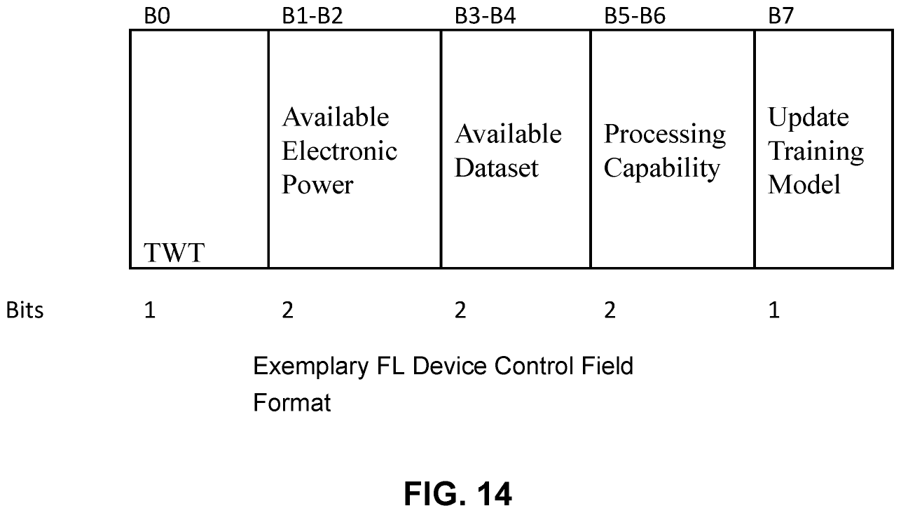

Example embodiments may utilize a FL Device Report Control Field. In one example embodiment, the STAs which report their operational parameters to the AP may indicate the type of operational parameters that are included in their report. FL Device Report Control field is described below. FIG. 14 depicts an exemplary FL Device Report Control field format. In an example embodiment, if TWT suggested parameters are included, the TWT value may be 1; otherwise TWT value may be 0.

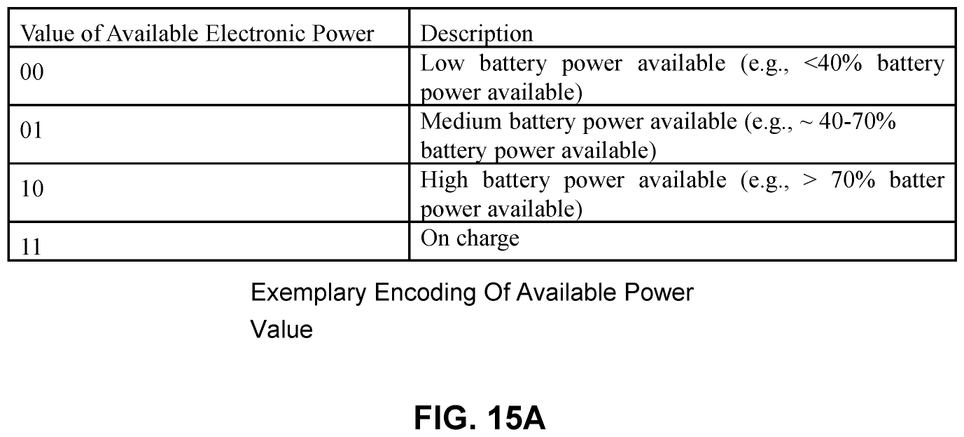

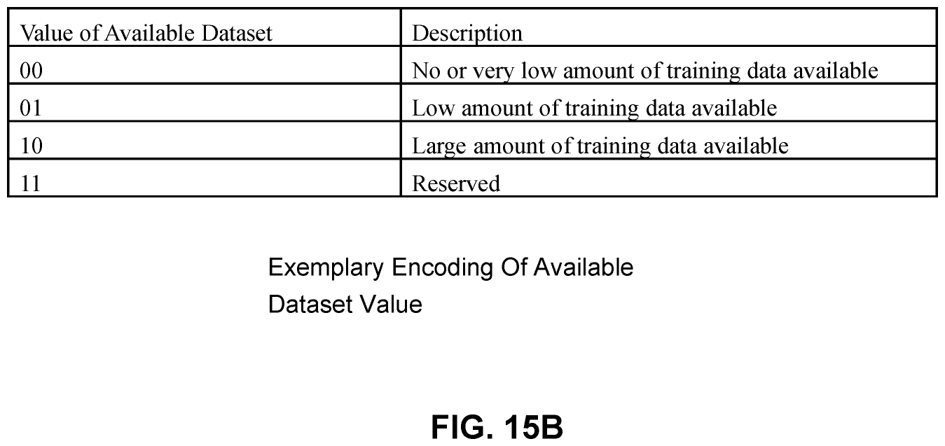

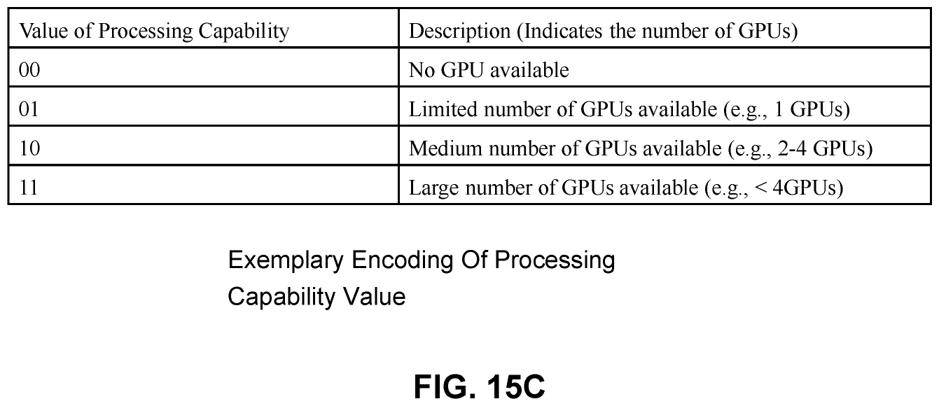

An example encoding of Available Electronic power value is depicted in FIG. 15A. An exemplary encoding of Available Dataset value is depicted in FIG. 15B. In FIG. 15B the values of very low amount, low amount, and large amount may be implementation dependent. Processing An example encoding of Processing Capability value is depicted in FIG. 15C. In an example embodiment, if the update training model is included, the Update Training Model value may 1; otherwise Update Training Model may 0.

Please note all the numbers shown in the description of above tables are exemplary numbers. It may change depending on the implementation. Although the features and elements of the present invention are described in the preferred embodiments in particular combinations, each feature or element can be used alone without the other features and elements of the preferred embodiments or in various combinations with or without other features and elements of the present invention.

Although the solutions described herein consider 802.11 specific protocols, it is understood that the solutions described herein are not restricted to this scenario and are applicable to other wireless systems as well. Although SIFS is used to indicate various inter frame spacing in the examples of the designs and procedures, all other inter frame spacing such as RIFS, AIFS, DIFS or other agreed time interval could be applied in the same solutions. Although four RBs per triggered TXOP are shown in some figures as example, the actual number of RBs/channels/bandwidth utilized may vary.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods, apparatuses, and articles of manufacture, within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

Although foregoing embodiments may be discussed, for simplicity, with regard to specific terminology and structure, (e.g., radio frequency (RF), microwave, centimeter wave, micrometer wave, infrared (IR), ultraviolet (UV), visible light, etc.), the embodiments discussed, however, are not limited to thereto, and may be applied to other systems that use other forms of electromagnetic waves or non-electromagnetic waves such as acoustic waves, for example.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis, or the like, or any appropriate combination thereof. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media, which are differentiated from signals, include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of methods, apparatuses, articles of manufacture, and systems provided above are possible without departing from the scope of the invention. In view of the wide variety of embodiments that can be applied, it should be understood that the illustrated embodiments are examples only, and should not be taken as limiting the scope of the following claims. For instance, embodiments provided herein include handheld devices, which may include or be utilized with any appropriate voltage source, such as a battery or the like, providing any appropriate voltage.

Moreover, in embodiments provided herein, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In example embodiments, several portions of the subject matter described herein may be implemented via Application Specific Integrated Circuits (ASICs), Field Programmable Gate Arrays (FPGAs), digital signal processors (DSPs), and/or other integrated formats. Those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. Those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

What is claimed is:

1-20. (canceled)

21. A method performed by a station, the method comprising:
receiving, via an access point (AP) associated with a basic service set (BSS) in a wireless local area network (WLAN), a learning model announcement frame indicating a model sharing process;
transmitting a support frame indicating participation in the model sharing process, the support frame comprising a set of parameters associated with a first model; and
updating the first model based at least upon the participation in the sharing model process.

22. The method of claim 21, wherein the learning model comprises at least one of a federated learning (FL) model or a machine learning (ML) model.

23. The method of either of claim 21, further comprising:
receiving a second support frame from a second station, the second support frame comprising a second set of parameters associated with a second model; and
updating the first model based on the second set of parameters.

24. The method of any of claim 21, wherein the model announcement frame comprises announcement parameters, the announcement parameters comprising at least one of a model identifier (ID), a number of model layers, or a number of weights per layer, the method further comprising configuring the station to update the first model in accordance with the announcement parameters.

25. The method of any of claim 21, further comprising:
receiving a gradient update for the first model; and
configuring the station to update the first model in accordance with the received gradient update.

26. The method of any of claim 21, further comprising:
training the first model; and
transmitting results of the training of the first model.

27. The method of any of claim 21, further comprising:
receiving a message comprising a target wake time (TWT); and
configuring the station to receive training parameters for the first model during the TWT.

28. A station comprising:
a transceiver; and
a processor configured to:
receive, via the transceiver and via an access point (AP) associated with a basic service set (BSS) in a wireless local area network (WLAN), a learning model announcement frame indicating a model sharing process;
transmit a support frame indicating participation in the model sharing process, the support frame comprising a set of parameters associated with a first model; and
update the first model based at least upon the participation in the sharing model process.

29. The station of claim 28, wherein the learning model comprises at least one of a federated learning (FL) model or a machine learning (ML) model.

30. The station of either of claim 28, the processor further configured to:
receive a second support frame from a second station, the second support frame comprising a second set of parameters associated with a second model; and
update the first model based on the second set of parameters.

31. The station of any of claim 28, wherein the model announcement frame comprises announcement parameters, the announcement parameters comprising at least one of a model identifier (ID), a number of model layers, or a number of weights per layer, the processor further configured to configure the station to update the first model in accordance with the announcement parameters.

32. The station of any of claim 28, wherein the announcement frame comprises at least one of an uplink (UL) schedule or a downlink (DL) schedule, the processor further configured to configure the station to transmit and receive in accordance with at least one of the UL schedule or the DL schedule.

33. The station of any of claim 28, the processor further configured to:
receive a gradient update for the first model; and
configure the station to update the first model in accordance with the received gradient update.

34. The station of any of claim 28, the processor further configured to:
train the first model; and
transmit results of the training of the first model.

35. The station of any of claim 28, the processor further configured to:
receive a message comprising a target wake time (TWT); and
configure the station to receive training parameters for the first model during the TWT.
